(19) United States
(12) Patent Application Publication
(10) Pub. No.: US 2025/0126476 A1
(43) Pub. Date: Apr. 17, 2025

(54) SECURITY DECISION NEGOTIATION METHOD AND NETWORK ELEMENT

(71) Applicant: HUAWEI TECHNOLOGIES CO., LTD., Shenzhen (CN)

(72) Inventors: Yurong SONG, Shenzhen (CN); Fei LIU, Singapore (SG); Donghui WANG, Beijing (CN)

(73) Assignee: HUAWEI TECHNOLOGIES CO., LTD., Shenzhen (CN)

(21) Appl. No.: 18/990,787

(22) Filed: Dec. 20, 2024

Related U.S. Application Data
(63) Continuation of application No. PCT/CN2023/097611, filed on May 31, 2023.

(30) Foreign Application Priority Data
Jun. 25, 2022 (CN) 202210728568.X

(51) Int. Cl. H04W 12/106

(52) U.S. Cl. CPC H04W 12/106

(57) ABSTRACT

A security decision negotiation method and a network element are applicable to various communication systems, such as an IoT system, an LTE system, a 5G system, an MTC system, an M2M system, a D2D system, a V2X system, and a WLAN system (such as Wi-Fi). The method includes: A first network element determines a security decision based on a security requirement of a requester and a security capability of a capability provider, and the first network element sends a message including the security decision. In embodiments of this application, flexibility of security

### CROSS-REFERENCE TO RELATED APPLICATIONS

This application is a continuation of International Application No. PCT/CN2023/097611, filed on May 31, 2023, which claims priority to Chinese Patent Application No. 202210728568.X, filed on Jun. 25, 2022. The disclosures of the aforementioned applications are hereby incorporated by reference in their entireties.

### TECHNICAL FIELD

This application relates to the field of communication technologies, and in particular, to a security decision negotiation method and a network element.

### BACKGROUND

Security decision negotiation in a 5th generation (5G) communication system is performed in a security mode command (security mode command) phase of a non-access stratum (NAS) protocol. A procedure is as follows: A core network device sends a security mode command message to a terminal device. The security mode command message carries a selected evolved packet system (EPS) NAS security algorithm information element (IE), to declare encryption and integrity protection algorithms provided by a network for the terminal device. Finally, the terminal device sets the encryption and integrity protection algorithms.

However, a future communication system may relate to more types of terminal devices, third-party devices, and the like. Therefore, the foregoing security decision negotiation method further needs to be improved.

### SUMMARY

Embodiments of this application provide a security decision negotiation method and a network element, to improve flexibility of security decision negotiation.

According to a first aspect, an embodiment of this application provides a security decision negotiation method. The method includes: A first network element determines a security decision based on a security requirement of a requester and a security capability of a capability provider; and the first network element sends a message including the security decision.

In this embodiment of this application, the first network element may effectively formulate the security decision with reference to the security requirement of the requester and the security capability of the capability provider, so that not only flexibility of security decision negotiation is improved, but also the requester and the capability provider can determine the security decision in a negotiation manner. This improves participation of the requester, and ensures reasonableness and effectiveness of the security decision.

In a possible implementation, the first network element includes the requester, and the method further includes: The requester receives a message including the security capability.

In a possible implementation, before the requester receives the message including the security capability, the method further includes: The requester sends a request message, where the request message is used to request the security capability of the capability provider.

In this embodiment of this application, the requester obtains the security capability of the capability provider, to determine the security decision with reference to the security requirement of the requester and the security capability of the capability provider. This effectively ensures that the requester can autonomously participate in a security decision negotiation procedure, and further makes formulation of the security decision more proper and effective.

In a possible implementation, the first network element includes the capability provider, and the method further includes: The capability provider receives a message including the security requirement.

In a possible implementation, before the capability provider receives the message including the security requirement, the method further includes: The capability provider sends a request message, where the request message is used to request the security requirement of the requester.

In this embodiment of this application, the capability provider obtains the security requirement of the requester, to determine the security decision with reference to the security requirement of the requester. This ensures that formulation of the security decision is more proper, and makes a security decision negotiation procedure more flexible.

In a possible implementation, before the first network element determines the security decision based on the security requirement of the requester and the security capability of the capability provider, the method further includes: The first network element obtains the security requirement and the security capability from a distributed ledger.

In this embodiment of this application, the security requirement and the security capability are stored in the distributed ledger, so that not only a communication network and a distributed ledger technology (a type of blockchain) can be effectively converged, but also security of the security requirement and the security capability can be improved.

In a possible implementation, that the first network element sends a message including the security decision includes: The first network element uploads the security decision to the distributed ledger.

In this embodiment of this application, the security decision is uploaded to the distributed ledger, so that a network element that needs to use the security decision subsequently can download the security decision from the distributed ledger. This ensures security of the security decision, and improves flexibility of obtaining the security decision by the network element that uses the security decision.

In a possible implementation, that a first network element determines a security decision based on a security requirement of a requester and a security capability of a capability provider includes: The first network element determines a value of a first bit in the security decision based on an operation or mapping result for a value of a first bit in the security requirement and a value of a first bit in the security capability; or the first network element determines the security decision based on priority information in the security requirement and the security capability.

According to a second aspect, an embodiment of this application provides a security decision negotiation method. The method includes: A requester sends a message including a security requirement; and the requester receives a message including a security decision, where the security decision corresponds to the security requirement.

In a possible implementation, that the security decision corresponds to the security requirement includes: The security decision is a result of negotiation based on the security requirement and a security capability of a capability provider.

According to a third aspect, an embodiment of this application provides a security decision negotiation method. The method includes: A capability provider sends a message including a security capability; and the capability provider receives a message including a security decision, where the security decision is a result of negotiation based on the security capability and a security requirement of a requester.

With reference to the first aspect, the second aspect, and the third aspect, in a possible implementation, the security requirement includes at least one of the following information: a security granularity, an authentication method, a key capability, privacy protection, a trustworthiness attestation, cross-operator, or the distributed ledger.

In this embodiment of this application, the security requirement includes the foregoing information, so that the first network element can formulate the security decision with reference to the security requirement of the requester. In this way, different types of requesters may have different security decisions, thereby improving flexibility of security decision negotiation and meeting differentiated security requirements.

With reference to the first aspect, the second aspect, and the third aspect, in a possible implementation, the security requirement includes priority information of at least one of the following information: an encryption algorithm, an integrity protection algorithm, the authentication method, the key capability, the privacy protection, the trustworthiness attestation, the cross-operator, or the distributed ledger.

In this embodiment of this application, the security requirement includes priority information of different security functions, so that the first network element can formulate the security decision with reference to different priority information and the security capability. This further improves accuracy of the security decision. With reference to the first aspect, the second aspect, and the third aspect, in a

possible implementation, the security decision is used to determine a trustworthiness vector (TV), and the TV includes at least one of the following information: the privacy protection, the trustworthiness attestation, the cross-operator, or the distributed ledger.

In this embodiment of this application, the TV includes more types of information, so that both communication parties can effectively perform communication based on the trustworthiness vector.

With reference to the first aspect, the second aspect, and the third aspect, in a possible implementation, the first network element includes any one of the following: a terminal device, an application function (AF), a trusted network element, an access and mobility management function (AMF), a network exposure function (NEF), an authentication server function (AUSF), and an access network device.

It should be noted that the capability provider and the demand side may be network elements of a same type, or may be network elements of different types. This is not limited in embodiments of this application.

According to a fourth aspect, an embodiment of this application provides a first network element, configured to perform the method according to any one of the first aspect or the possible implementations of the first aspect. The first network element includes a unit for performing any one of the first aspect or the possible implementations of the first aspect.

According to a fifth aspect, an embodiment of this application provides a demand side, configured to perform the method according to any one of the second aspect or the possible implementations of the second aspect. The demand side includes a unit for performing the second aspect or any possible implementation.

According to a sixth aspect, an embodiment of this application provides a capability provider, configured to perform the method according to any one of the third aspect or the possible implementations of the third aspect. The capability provider includes a unit for performing any one of the third aspect or the possible implementations of the third aspect.

According to a seventh aspect, an embodiment of this application provides a first network element. The first network element includes a processor, configured to perform the method according to any one of the first aspect or the possible implementations of the first aspect. Alternatively, the processor is configured to execute a program stored in a memory. When the program is executed, the method according to any one of the first aspect or the possible implementations of the first aspect is performed.

In a possible implementation, the memory is located outside the first network element.

In a possible implementation, the memory is located inside the first network element.

In this embodiment of this application, the processor and the memory may alternatively be integrated into one device. In other words, the processor and the memory may alternatively be integrated together.

In a possible implementation, the first network element further includes a transceiver, and the transceiver is configured to receive a signal or send a signal.

According to an eighth aspect, an embodiment of this application provides a demand side. The demand side includes a processor, configured to perform the method according to the second aspect or any possible implementation. Alternatively, the processor is configured to execute a program stored in a memory. When the program is executed, the method according to any one of the second aspect or the possible implementations of the second aspect is performed.

In a possible implementation, the memory is located outside the requester.

In a possible implementation, the memory is located inside the requester.

In this embodiment of this application, the processor and the memory may alternatively be integrated into one device. In other words, the processor and the memory may alternatively be integrated together.

In a possible implementation, the requester further includes a transceiver, and the transceiver is configured to receive a signal or send a signal.

According to a ninth aspect, an embodiment of this application provides a capability provider. The capability provider includes a processor, configured to perform the method according to the third aspect or any possible implementation. Alternatively, the processor is configured to execute a program stored in a memory. When the program is executed, the method according to any one of the third aspect or the possible implementations of the third aspect is performed.

In a possible implementation, the memory is located outside the capability provider.

In a possible implementation, the memory is located inside the capability provider.

In this embodiment of this application, the processor and the memory may alternatively be integrated into one device. In other words, the processor and the memory may alternatively be integrated together.

In a possible implementation, the capability provider further includes a transceiver, and the transceiver is configured to receive a signal or send a signal.

According to a tenth aspect, an embodiment of this application provides a first network element. The first network element includes a logic circuit and an interface, and the logic circuit is coupled to the interface. The logic circuit is configured to determine a security decision based on a security requirement of a requester and a security capability of a capability provider, and the interface is configured to output a message including the security decision.

In a possible implementation, the interface is further configured to input a message including the security capability.

In a possible implementation, the interface is further configured to output a request message, where the request message is used to request the security capability of the capability provider.

In a possible implementation, the interface is further configured to input a message including the security requirement.

In a possible implementation, the interface is further configured to output a request message, where the request message is used to request the security requirement of the requester.

In a possible implementation, the logic circuit is specifically configured to obtain the security requirement and the security capability from a distributed ledger.

In a possible implementation, the logic circuit is specifically configured to upload the security decision to the distributed ledger by using the interface.

In a possible implementation, the logic circuit is specifically configured to: determine a value of a first bit in the security decision based on an operation or mapping result for a value of a first bit in the security requirement and a value of a first bit in the security capability; or determine the security decision based on priority information in the security requirement and the security capability.

According to an eleventh aspect, an embodiment of this application provides a requester. The requester includes a logic circuit and an interface, and the logic circuit is coupled to the interface. The logic circuit is configured to: output, through the interface, a message including a security requirement; and input, through the interface, a message including a security decision, where the security decision corresponds to the security requirement.

According to a twelfth aspect, an embodiment of this application provides a capability provider. The capability provider includes a logic circuit and an interface, and the logic circuit is coupled to the interface. The logic circuit is configured to output, through the interface, a message including a security capability; and input, through the interface, a message including a security decision, where the security decision is a result of negotiation based on the security capability and a security requirement of a requester.

According to a thirteenth aspect, an embodiment of this application provides a computer-readable storage medium. The computer-readable storage medium is configured to store a computer program, and when the computer program is run on a computer, the method according to any one of the first aspect or the possible implementations of the first aspect is performed.

According to a fourteenth aspect, an embodiment of this application provides a computer-readable storage medium. The computer-readable storage medium is configured to store a computer program, and when the computer program is run on a computer, the method according to any one of the second aspect or the possible implementations of the second aspect is performed.

According to a fifteenth aspect, an embodiment of this application provides a computer-readable storage medium. The computer-readable storage medium is configured to store a computer program, and when the computer program is run on a computer, the method according to any one of the third aspect or the possible implementations of the third aspect is performed.

According to a sixteenth aspect, an embodiment of this application provides a computer program product. The computer program product includes a computer program or computer code or instructions. When the computer program product runs on a computer, the method according to any one of the first aspect or the possible implementations of the first aspect is performed.

According to a seventeenth aspect, an embodiment of this application provides a computer program product. The computer program product includes a computer program or computer code or instructions. When the computer program product runs on a computer, the method according to any one of the second aspect or the possible implementations of the second aspect is performed.

According to an eighteenth aspect, an embodiment of this application provides a computer program product. The computer program product includes a computer program or computer code or instructions. When the computer program product runs on a computer, the method according to any one of the third aspect or the possible implementations of the third aspect is performed.

According to a nineteenth aspect, an embodiment of this application provides a computer program. When the computer program is run on a computer, the method according to any one of the first aspect or the possible implementations of the first aspect is performed.

According to a twentieth aspect, an embodiment of this application provides a computer program. When the computer program is run on a computer, the method according to any one of the second aspect or the possible implementations of the second aspect is performed.

According to a twenty-first aspect, an embodiment of this application provides a computer program. When the computer program is run on a computer, the method according to any one of the third aspect or the possible implementations of the third aspect is performed.

According to a twenty-second aspect, an embodiment of this application provides a communication system. The communication system includes a first network element and a requester, the first network element is configured to perform the method according to the first aspect, and the requester is configured to perform the method according to the second aspect; or the communication system includes a first network element and a capability provider, the first network element is configured to perform the method according to the first aspect, and the capability provider is configured to perform the method according to the third aspect.

Optionally, the communication system includes a requester and a capability provider. For specific descriptions of the requester and the capability provider, refer to the following. Details are not described herein first. The requester and the capability provider shown in the foregoing aspects each may be understood as a network element.

For beneficial effects of the second aspect to the twenty-second aspect, refer to the first aspect.

### BRIEF DESCRIPTION OF DRAWINGS

FIG. 1 is a diagram of an architecture of a communication system according to an embodiment of this application;

FIG. 2 is a schematic flowchart of a security decision negotiation method according to an embodiment of this application;

FIG. 3 is a schematic flowchart of a security decision negotiation method according to an embodiment of this application;

FIG. 4a is a diagram of a structure of a security requirement according to an embodiment of this application;

FIG. 4b is a diagram of a structure of a security capability according to an embodiment of this application;

FIG. 4c is a diagram of a structure of a security decision according to an embodiment of this application;

FIG. 5a is a diagram of a structure including priority information according to an embodiment of this application;

FIG. 5b is a diagram of a structure including priority information according to an embodiment of this application;

FIG. 5c is a diagram of a structure of a trustworthiness vector according to an embodiment of this application;

FIG. 6a is a schematic flowchart of a security decision negotiation method according to an embodiment of this application;

FIG. 6b is a schematic flowchart of a security decision negotiation method according to an embodiment of this application;

FIG. 7a is a schematic flowchart of a security decision negotiation method according to an embodiment of this application;

FIG. 7b is a schematic flowchart of a security decision negotiation method according to an embodiment of this application;

FIG. 8 is a schematic flowchart of a security decision negotiation method according to an embodiment of this application;

FIG. 9a is a schematic flowchart of a security decision negotiation method according to an embodiment of this application;

FIG. 9b is a schematic flowchart of a security decision negotiation method according to an embodiment of this application;

FIG. 9c is a schematic flowchart of a security decision negotiation method according to an embodiment of this application;

FIG. 9d is a schematic flowchart of a security decision negotiation method according to an embodiment of this application;

FIG. 10a is a schematic flowchart of a security decision negotiation method according to an embodiment of this application;

FIG. 10b is a schematic flowchart of a security decision negotiation method according to an embodiment of this application;

FIG. 11a is a schematic flowchart of a security decision negotiation method according to an embodiment of this application;

FIG. 11b is a schematic flowchart of a security decision negotiation method according to an embodiment of this application;

FIG. 12a is a schematic flowchart of a security decision negotiation method according to an embodiment of this application;

FIG. 12b is a schematic flowchart of a security decision negotiation method according to an embodiment of this application;

FIG. 13a is a schematic flowchart of uploading a security tag according to an embodiment of this application;

FIG. 13b is a schematic flowchart of downloading a security tag according to an embodiment of this application;

FIG. 13c is a schematic flowchart of updating a security tag according to an embodiment of this application;

FIG. 14 is a diagram of a structure of a network element according to an embodiment of this application;

FIG. 15 is a diagram of a structure of a network element according to an embodiment of this application; and

FIG. 16 is a diagram of a structure of a network element according to an embodiment of this application.

### DESCRIPTION OF EMBODIMENTS

To make the objectives, technical solutions, and advantages of this application clearer, the following further describes this application with reference to the accompanying drawings.

The terms “first”, “second”, and the like in the specification, claims, and accompanying drawings of this application are used to distinguish between different objects, but are not used to describe a specific sequence. In addition, the terms “include” and “have” and any variations thereof are intended to cover non-exclusive inclusion. For example, a process, method, system, product, or device that includes a series of steps or units is not limited to the listed steps or units, but optionally further includes an unlisted step or unit, or optionally further includes another inherent step or unit for the process, method, product, or device.

The “embodiment” mentioned in this specification means that specific features, structures, or characteristics described with reference to the embodiment may be included in at least one embodiment of this application. Appearance of the phrase at various locations in the specification does not necessarily refer to a same embodiment, or an independent or alternative embodiment mutually exclusive with another embodiment. A person skilled in the art may explicitly and implicitly understand that the embodiments described in this specification may be combined with other embodiments.

In this application, “at least one (piece)” refers to one or more, “a plurality of” refers to two or more, “at least two (pieces)” refers to two, three, or more, and “and/or” is used to describe an association relationship of associated objects, and indicates that three relationships may exist. For example, “A and/or B” may indicate the following three cases: Only A exists, only B exists, and both A and B exist, where A and B may be singular or plural. “Or” indicates that two relationships may exist, for example, only A exists and only B exists. When A and B are not mutually exclusive, it may indicate that three relationships exist, for example, only A exists, only B exists, and both A and B exist. The character “/” generally indicates an “or” relationship between associated objects. “At least one of the following items (pieces)” or a similar expression thereof means any combination of these items. For example, at least one of a, b, or c may represent a, b, c, “a and b”, “a and c”, “b and c”, or “a, b, and c”.

The technical solutions provided in embodiments of this application may be applied to various communication systems, for example, an internet of things (IoT) system, a narrowband internet of things (NB-IoT) system, a long term evolution (LTE) system, a 5th generation (5G) communication system, and a new communication system emerging in future communication development, such as a 6th generation (6G) communication system.

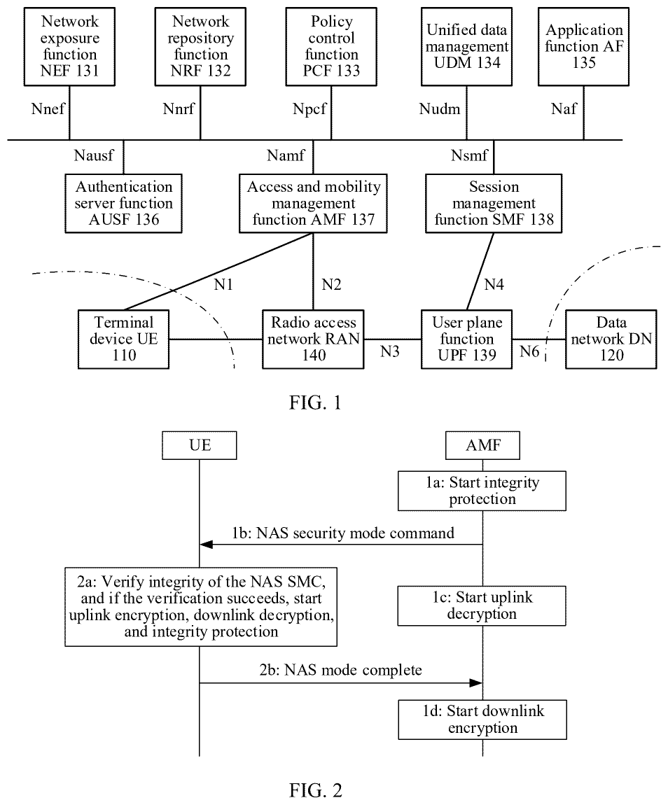

The technical solutions provided in embodiments of this application may be further applied to machine type communication (MTC), a long term evolution-machine (LTE-M) technology, a device-to-device (D2D) network, a machine-to-machine (M2M) network, an internet of things (IoT) network, an industrial internet, or another network. The IoT network may include, for example, an internet of vehicles. Communication manners in an internet of vehicles system are collectively referred to as vehicle-to-everything (V2X, where X may represent everything). For example, V2X may include vehicle-to-vehicle (V2V) communication, vehicle-to-infrastructure (V2I) communication, vehicle-to-pedestrian (V2P) communication, or vehicle-to-network (V2N) communication. For example, in FIG. 1 shown below, terminal devices may communicate with each other by using the D2D technology, the M2M technology, the V2X technology, or the like.

The technical solutions provided in embodiments of this application may be further applied to a wireless local area network (WLAN) system, for example, Wi-Fi. For example, the method provided in embodiments of this application is applicable to the institute of electrical and electronics engineers (IEEE) 802.11 series protocols, such as the 802.11a/b/g protocol, the 802.11n protocol, the 802.11ac protocol, the 802.11ax protocol, the 802.11be protocol, or a next-generation protocol, which are not enumerated one by one herein.

For example, embodiments of this application are applied to a 5G communication system. The following describes network functions in the 5G system by using an example.

Refer to FIG. 1. A 5G network architecture that is based on a service-based architecture and that is defined in a 3rd generation partnership project (3GPP) standardization process is used as an example of a network architecture shown in FIG. 1. As shown in FIG. 1, the network architecture may include at least three parts: a terminal device part, an operator network part, a data network (DN) part, and the like.

The terminal device part may include a terminal device 110, and the terminal device 110 may also be referred to as user equipment (UE). The terminal device 110 in this embodiment of this application is a device having wireless receiving and sending functions, and may communicate with one or more core network (CN) devices (or may be referred to as core devices) through an access network device (or may be referred to as an access device) in a radio access network (RAN) 140. The terminal device 110 may also be referred to as an access terminal, a terminal, a subscriber unit, a subscriber station, a mobile station, a remote station, a remote terminal, a mobile device, a user terminal, a user agent, a user apparatus, or the like. In a possible implementation, the terminal device 110 may be deployed on land, and include an indoor or outdoor terminal device, a handheld terminal device, or a vehicle-mounted terminal device; or may be deployed on a water surface (for example, on a ship); or may be deployed in the air (for example, on an aircraft, a balloon, or a satellite). In a possible implementation, the terminal device 110 may be a handheld device having a wireless communication function, a vehicle-mounted device, a wearable device, a terminal in the internet of things or the internet of vehicles, a terminal in any form in a 5G network and a future network, or the like. This is not limited in embodiments of this application. The terminal device shown in this embodiment of this application may further include a vehicle (for example, an entire vehicle) in the internet of vehicles, and may further include a vehicle-mounted device, a vehicle-mounted terminal, or the like in the internet of vehicles. A specific form of the terminal device used in the internet of vehicles is not limited in embodiments of this application.

A part operated by an operator in various communication systems may be referred to as an operator network, a public land mobile network (PLMN) network, or the like. The operator network is mainly a public network used by a mobile network operator (MNO) to provide a mobile broadband access service for a user. For example, the operator network or the PLMN network in embodiments of this application may alternatively be a network that meets a requirement of a 3GPP standard, which is referred to as a 3GPP network for short. The 3GPP network may be usually operated by an operator, and includes but is not limited to a 5th generation (5G) mobile communication network (5G network for short), a 4th generation (4G) mobile communication network (4G network for short), or the like.

As shown in FIG. 1, the operator network may include: an NEF 131, a network repository function (NRF) 132, a policy control function (policy control function, PCF) 133, a unified data management (UDM) 134, an AF 135, an AUSF 136, an AMF 137, a session management function (SMF) 138, a user plane function (UPF) 139, a radio access network (RAN) 140, and the like. In the foregoing operator network, a part other than the RAN 140 part may be referred to as a core network (CN) part.

A data network DN 120 may also be referred to as a packet data network (PDN), and is usually a network outside the operator network. For example, the operator network may access a plurality of data networks DNs 120, and a plurality of services may be deployed on the data networks DNs 120, to provide services such as a data service and/or a voice service for the terminal device 110. The foregoing specific representation form may be specifically determined based on an actual application scenario. This is not limited in embodiments of this application.

For example, the following briefly describes network functions in the operator network.

The RAN 140 is a sub-network of the operator network, and is an implementation system between a service node in the operator network and the terminal device 110. To access the operator network, the terminal device 110 first accesses the RAN 140, and then connects to a network function in the operator network through the RAN 140. The access network device in embodiments of this application is a device that provides a wireless communication function for the terminal device 110, and may also be referred to as an access device, a RAN device, or the like. The RAN device includes but is not limited to a next generation NodeB (gNB) in a 5G system, an evolved NodeB (eNB) in an LTE system, a radio network controller (RNC), a NodeB (NB), a base station controller (BSC), a base transceiver station (BTS), a home evolved NodeB or home NodeB (HNB), a baseband unit (BBU), a transmitting and receiving point (TRP), a transmitting point (TP), a small cell device (pico), a mobile switching center, a network device having a base station function in a future network, or the like. It may be understood that a specific type of the access network device is not limited in embodiments of this application. In systems using different radio access technologies, devices with functions of the access network device may have different names.

The NEF (which may also be referred to as an NEF network function or an NEF network function entity) 131 is a control plane function provided by an operator. The NEF 131 exposes an external interface of the operator network to the AF in a secure manner. When the SMF 138 needs to communicate with a network function of the AF, the NEF 131 may serve as a relay for communication between the SMF 138 and a network entity of the AF. When serving as the relay, the NEF 131 may serve as a translator for identification information of a subscriber and a translator for identification information of the network function of the AF. For example, when sending a subscriber permanent identifier (SUPI) of the subscriber from the operator network to the AF, the NEF 131 may translate the SUPI into an external identity (ID) corresponding to the SUPI. Conversely, when sending an external ID (a network entity ID of the AF) to the operator network, the NEF 131 may translate the external ID into an SUPI.

The NRF 132 may be configured to maintain real-time information of all network function services in a network.

The PCF 133 is a control plane function provided by an operator, and is configured to provide a PDU session policy for the session management function SMF 138. The policy may include a charging-related policy, a QoS-related policy, an authorization-related policy, and the like.

The UDM 134 is a control plane function provided by an operator, and is responsible for storing information such as an SUPI, a security context (security context), and subscription data of a subscribed user in the operator network.

The AF 135 is configured to perform data routing affected by an application, access the network exposure function, interact with a policy framework for policy control, and the like.

The AUSF 136 is a control plane function provided by an operator, and is usually used for primary authentication, that is, authentication between the terminal device 110 (a subscriber) and the operator network.

The AMF 137 is a control plane network function provided by the operator network, and is responsible for access control and mobility management when the terminal device 110 accesses the operator network, for example, including functions such as mobility status management, allocation of a temporary user identity, and user authentication and authorization.

The SMF 138 is a control plane network function provided by the operator network, and is responsible for managing a protocol data unit (PDU) session of the terminal device 110. The PDU session is a channel for transmitting a PDU, and the terminal device and the DN 120 need to transmit PDUs to each other through the PDU session. The SMF 138 may be responsible for establishment, maintenance, deletion, and the like the PDU session. The SMF 138 includes session-related functions such as session management (such as session establishment, modification, and release, including tunnel maintenance between the UPF 139 and the RAN 140), selection and control of the UPF 139, service and session continuity (SSC) mode selection, and roaming.

The UPF 139 is a gateway provided by an operator, and is a gateway for communication between the operator network and the DN 120. The UPF 139 includes user plane-related functions such as data packet routing and transmission, packet detection, service usage reporting, quality of service (QOS) processing, uplink packet detection, and downlink data packet storage.

The network functions in the operator network shown in FIG. 1 may further include a unified data repository (UDR). For a function of the UDR, refer to the UDM. Details are not described herein.

In FIG. 1, Nnef, Nausf, Nnrf, Npcf, Nudm, Naf, Namf, Nsmf, N1, N2, N3, N4, and N6 are interface sequence numbers. For example, for meanings of the interface sequence numbers, refer to meanings defined in the 3GPP standard protocol. The meanings of the interface sequence numbers are not limited in embodiments of this application. It should be noted that in FIG. 1, only an example in which the terminal device 110 is UE is used for description. Names of interfaces between the network functions in FIG. 1 are also merely examples. In specific implementation, the names of the interfaces in the system architecture may alternatively be other names. This is not limited in embodiments of this application.

A mobility management network function in embodiments of this application may be the AMF 137 shown in FIG. 1, or may be another network function having the foregoing access and mobility management function AMF 137 in a future communication system. Alternatively, the mobility management network function in this application may be a mobility management entity (MME) or the like in an LTE system. For ease of description, in embodiments of this application, the access and mobility management function AMF 137 is referred to as an AMF for short, and the terminal device 110 is referred to as UE. In other words, in subsequent descriptions in embodiments of this application, the AMF may be replaced with a mobility management network function, and the UE may be replaced with a terminal device. It may be understood that the replacement method is also applicable to another network function that is not shown.

A service-based architecture and a universal interface are used for the network architecture (for example, a 5G network architecture) shown in FIG. 1. A conventional network element function is split into several self-contained, self-managed, and reusable network function service modules based on a network function virtualization (NFV) technology. The diagram of the network architecture shown in FIG. 1 may be understood as a diagram of a service-based 5G network architecture in a non-roaming scenario. Embodiments of this application are also applicable to a roaming scenario.

FIG. 2 is a schematic flowchart of a security decision negotiation method according to an embodiment of this application. As shown in FIG. 2, the method includes the following steps.

1a: An AMF starts integrity protection (start integrity protection).

1b: The AMF sends a non-access stratum security mode command (NAS SMC) to UE, where the NAS security mode command carries a selected EPS NAS security algorithm IE, used to declare encryption and integrity protection algorithms provided by a network for the UE. Correspondingly, the UE receives the NAS security mode command.

1c: The AMF starts uplink decryption.

2a: The UE verifies integrity of the NAS SMC, and if the verification succeeds, starts uplink encryption, downlink decryption, and integrity protection.

2b: The UE sends a NAS mode complete (NSA mode complete) to the AMF. Correspondingly, the AMF receives the NAS mode complete.

1d: The AMF starts downlink encryption.

It can be learned from the foregoing security decision negotiation method that a security decision is formulated by a core network. For example, the AMF formulates the encryption algorithm and the integrity protection algorithm. In other words, the UE cannot participate in a security decision negotiation procedure, and cannot actively report a security requirement of the UE to a network side. Consequently, the security decision negotiation method shown in FIG. 2 is not flexible enough.

In view of this, embodiments of this application provide a security decision negotiation method and a network element. A first network element can formulate a security decision with reference to a security requirement of a requester and a security capability of a capability provider, thereby improving flexibility of security decision negotiation. For example, the first network element formulates the security decision with reference to the security requirement of the requester. In this way, different types of requesters may have different security decisions, thereby improving flexibility of security decision negotiation and meeting differentiated security requirements. For example, the requester may actively report the security requirement of the requester, so that the first network element can formulate the security decision with reference to the security requirement of the requester. In this way, a security decision negotiation procedure is more flexible. For example, in embodiments of this application, the security decision may be formulated with reference to more security functions, so that different security functions may be set for different types of requesters, thereby improving flexibility of security function setting.

More types of terminal devices or AFs may be related to a future network, and different terminal devices or AFs have different security requirements and security capabilities. For example, a lightweight device may use lightweight authentication, encryption, and integrity protection algorithms. In this way, according to the method provided in embodiments of this application, the first network element may activate some security functions based on a requirement of the lightweight device. For example, security functions that can be used by the lightweight device includes: an encryption key length less than or equal to a first length, an integrity protection key length less than or equal to a second length, an encryption algorithm, an integrity protection algorithm, an authentication method (for example, certificate-based identity authentication), a tag attribute, and a security granularity. For another example, a third party in the industrial internet may use a fast and low-latency security algorithm. According to the method provided in embodiments of this application, the first network element may activate a fast and low-latency security function based on a requirement of the industrial internet. For example, a security function that can be used by the industrial internet includes: using a symmetric key for authentication, or if an asymmetric key is used, using a lightweight implicit certificate for authentication. For another example, a confidential device requires an enhanced data and privacy protection technology and a complex security algorithm. According to the method provided in embodiments of this application, the first network element may activate most or all security functions based on a requirement of the confidential device. For another example, a device with a high computing capability may use an artificial intelligence (AI)-based security algorithm. According to the method provided in embodiments of this application, the first network element may activate an AI-based security function based on a requirement of the device with the high computing capability. For example, security functions that can be used by a function with a high computing capability include: using encryption and integrity protection algorithms whose key lengths are greater than a third length, a post-quantum encryption algorithm, and a distributed ledger. It may be understood that the foregoing various types of network elements and security functions used by the network elements are merely examples, and should not be construed as a limitation on embodiments of this application.

Terminal devices of different types may use different security functions, and terminal devices of a same type may also use different security functions based on different scenarios. A future network may involve more abundant security scenarios, and a same terminal device or AF has different security requirements in different scenarios. For example, in a large-scale communication scenario, lightweight authentication may be used to activate an automatic detection function for a device and traffic. In a high-reliability and low-latency scenario, a post-quantum encryption algorithm and a lightweight security algorithm may be used. In a fast moving scenario, a cross-region and cross-operator capability of a terminal device and a third-party application may be implemented. For example, a user has a cross-operator unified credential (credentials) (which may be understood as a cross-operator subscriber identification module (SIM) card), which may be authenticated by a plurality of operators.

The first network element shown in embodiments of this application may be described as follows:

In an example, the first network element shown in embodiments of this application may be a requester, or may be a capability provider. The requester may be understood as any network element that has a security requirement, and the capability provider may be understood as any network element that can provide a security capability. Specific product forms of the requester and the capability provider are not limited in embodiments of this application. It may be understood that the capability provider and the requester are relative. In other words, the capability provider may provide some security functions relative to the requester, and therefore is referred to as the capability provider. For example, the capability provider may be a network function in a core network, a device in an access network, or the like, and the requester may be a terminal device or the like. For another example, the capability provider may be an access point (access point, AP), and the requester may be a station (station, STA). If both communication parties are network elements of a same type, for example, both are network elements in a core network, the capability provider and the requester may alternatively be distinguished based on capabilities, or the capability provider and the requester may be distinguished based on functions of the network elements. If both communication parties are network elements of a same type and have similar capabilities, both communication parties may be referred to as requesters, for example, two terminals in D2D, or two vehicle-mounted terminals in V2X. Certainly, names of the capability provider and the requester are merely examples, and specific names of the capability provider and the requester are not limited in embodiments of this application.

In another example, the first network element shown in embodiments of this application may be a network element other than a requester and a capability provider.

For example, the first network element includes any one of the following: a terminal device, an AF, a trusted network element, an AMF, an NEF, an AUSF, and an access network device (such as a base station). The first network element shown herein is merely an example, and should not be construed as a limitation on embodiments of this application. The trusted network element may be described as follows:

The trusted network element may be understood as a trusted network function, a network element having a trusted function, or the like. The trusted network element may be responsible for managing at least one of the following: generating a security requirement, updating a security requirement, deleting a security requirement, generating a security capability, updating a security capability, deleting a security capability, or determining (or formulating) a security decision. In an example, the trusted network element may be an independent network element, for example, exist in a core network. In another example, the trusted network element may be integrated with a requester, a capability provider, and a third party other than the requester and the capability provider, so that the requester, the capability provider, and the third party have functions of the trusted network element. For example, the trusted network element is integrated with any one of a terminal device, a network function in a core network, and an access network device, so that the terminal device, the network element in the core network, and the access network device have functions of the trusted network element. In another example, a terminal device, a network element in a core network, an access network device, and the like have functions of the trusted network element. For example, the core network and the terminal device may include an atomic security algorithm, which may also be understood as a set of security algorithms or a security resource pool (security resource pool).

For example, a specific function of the trusted network element may include at least one of the following, or refer to Table 1.

(1) The trusted network element may generate a security capability.

(2) The trusted network element may provide a security capability for another functional module, or upload a security capability to a distributed ledger.

(3) The trusted network element may call an interface based on a security decision configuration, so that another functional module calls a security function specified in a security decision.

(4) If another functional module initiates a request, the trusted network element may send a security tag to the another functional module. It may be understood that the security tag shown in embodiments of this application includes at least one of a security requirement, a security capability, and a security decision.

(5) If a distributed ledger is introduced into a communication network, the trusted network element may upload a security tag to the distributed ledger, or may download an old security tag from the distributed ledger. The old security tag shown herein may also be understood as a historical security tag.

(6) The trusted network element may generate a security requirement.

(7) After receiving a new security requirement, the trusted network element may determine a new security decision.

(8) After a stored security tag expires, the trusted network element may discard the old security tag and generate a new security tag.

TABLE 1

| Service name | Specific description | Service object |
|---|---|---|
| Security capability obtain | Generate a security capability | |
| (SecurityEnablerExpose) | | |
| Security capability control | Call an interface based on a security | |
| (SecurityEnablerControl) | decision setting | |
| Security tag provide | Provide a required security tag for | Core network function |
| (SecurityTagProvide) | another functional module | and terminal device |
| Blockchain upload | Support in uploading a security tag to a | Blockchain node |
| (BlockchainUpload) | distributed ledger | (BlockChain node) |
| Blockchain download | Support in downloading a security tag | Blockchain node |
| (BlockchainDownload) | from a distributed ledger | |
| Security tag control | Generate, update, or delete a security tag | |
| (SecurityTagControl) | | |

The foregoing descriptions of the first network element and the trusted network element are also applicable to the following.

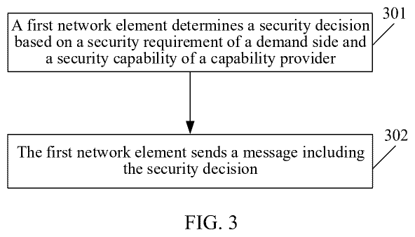

FIG. 3 is a schematic flowchart of a security decision negotiation method according to an embodiment of this application. For example, each network element in the following may have some or all functions shown in Table 1. As shown in FIG. 3, the method includes the following steps.

301: A first network element determines a security decision based on a security requirement of a requester and a security capability of a capability provider.

The security requirement may be understood as a security algorithm declared by the requester, a security algorithm needed by the requester, or a security algorithm or a security function required by the requester. The security capability may be understood as a security algorithm that is declared and can be provided by the capability provider, or a security algorithm or a security function that can be provided by the capability provider for the requester. The security decision may be understood as a finally negotiated security algorithm, a finally determined security algorithm based on the security requirement and the security capability, or a finally negotiated security function. It may be understood that the security decision shown in this embodiment of this application may be further understood as a security negotiation result, a security algorithm negotiation result, a security policy negotiation result, a security policy, or the like. A specific name of the security decision is not limited in this embodiment of this application. It may be understood that the security decision not only includes some security algorithms, but also includes some non-algorithm information, such as an attribute, a security granularity, a trustworthiness attestation, cross-operator, and a distributed ledger. Therefore, a result of negotiation based on the security decision may be referred to as a security function, and the security function may include some negotiated security algorithms.

For example, the security requirement may include at least one of the following information (or referred to as requirements): an attribute (for example, a tag attribute), a security granularity, an authentication method, an encryption algorithm, an encryption key length, an integrity protection algorithm, an integrity protection key length, a key capability, privacy protection, a trustworthiness attestation, cross-operator, or a distributed ledger. For example, the security capability may include at least one of the following information (or referred to as capabilities): an attribute (for example, a tag attribute), a security granularity, an authentication method, an encryption algorithm, an encryption key length, an integrity protection algorithm, an integrity protection key length, a key capability, privacy protection, a trustworthiness attestation, cross-operator, or a distributed ledger. For example, the security decision may include at least one of the following information: an attribute, a security granularity, an authentication method, an encryption algorithm, an encryption key length, an integrity protection algorithm, an integrity protection key length, a key capability, privacy protection, a trustworthiness attestation, cross-operator, or a distributed ledger.

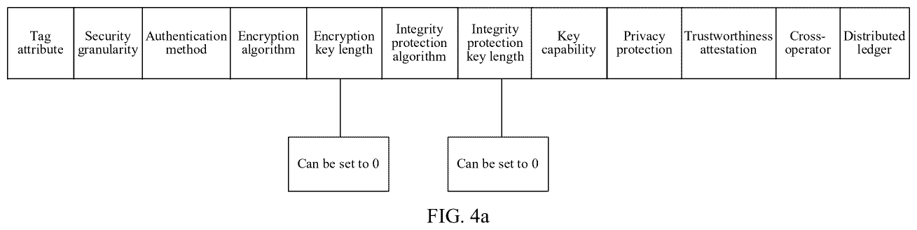

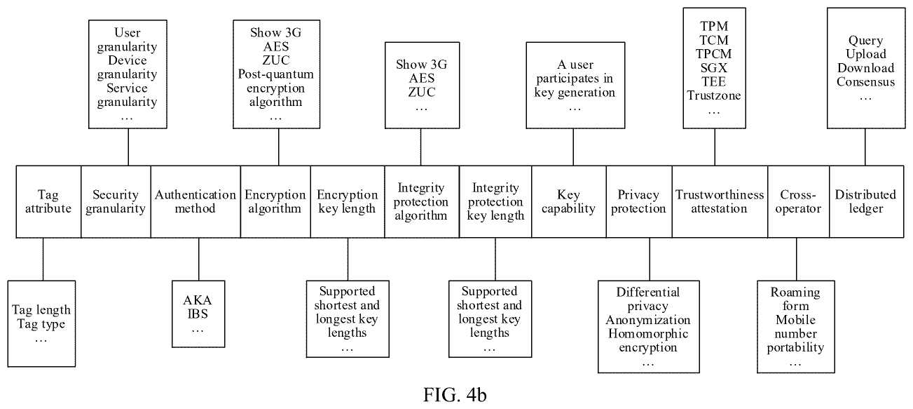

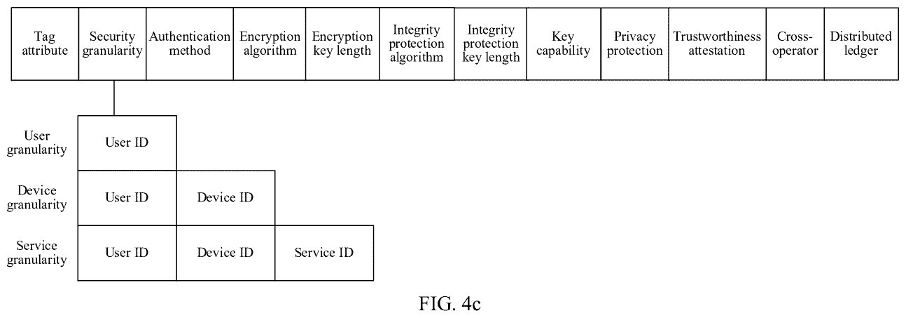

For example, FIG. 4a is a diagram of a structure of a security requirement according to an embodiment of this application. FIG. 4b is a diagram of a structure of a security capability according to an embodiment of this application. FIG. 4c is a diagram of a structure of a security decision according to an embodiment of this application. It may be understood that a sequence of information in FIG. 4a to FIG. 4c is merely an example, and should not be construed as a limitation on embodiments of this application. In specific implementation, the security requirement may have more information than that in FIG. 4a, or may have less information than that in FIG. 4a. This is not limited in this embodiment of this application. Similarly, the foregoing description about the security requirement is also applicable to the security capability and the security decision. Structure forms of the security requirement, the security capability, and the security decision may be the same, but values of corresponding fields of the security requirement, the security capability, and the security decision may be different. For example, the requester may set a value of a corresponding field based on a requirement of the requester, and the capability provider may set a value of a corresponding field based on a capability of the capability provider. A value of a corresponding field in the security decision may be determined by the value of the corresponding field in the security requirement and the value of the field in the security capability. For a method for determining the security decision, refer to the following. Details are not described one by one herein first.

The security requirement may also be referred to as a security requirement tag, the security capability may also be referred to as a security capability tag, and the security decision may also be referred to as a security decision tag. The security requirement tag, the security capability tag, and the security decision tag may also be collectively referred to as a security tag, a tag, or the like. This is not limited in this embodiment of this application. For ease of description, blocks shown in FIG. 4a to FIG. 4c are referred to as fields below, such as a tag attribute field and a security granularity field, which are not listed one by one herein. Certainly, descriptions of the fields shown herein are merely examples. For example, each block may also be referred to as an information bit, such as a tag attribute information bit or a security granularity information bit. This is not limited in this embodiment of this application. For ease of description, in embodiments of this application, the security requirement, the security capability, and the security decision are collectively referred to as a security tag, but this should not be construed as a limitation on embodiments of this application.

Information that may be included in the security requirement, the security capability, and the security decision is described as follows:

A tag attribute may be used to carry some attributes related to a tag, for example, include at least one of a tag length and a tag type. The tag length may indicate a length of the security requirement or the security capability, and may be measured by bits, or may be measured by bytes. This is not limited in this embodiment of this application. The tag type may indicate any one of the security requirement, the security capability, and the security decision. The security tag carries the tag attribute, so that a network element that receives the security tag can effectively learn of a type and a length of the security tag, thereby ensuring that the requester and the capability provider have consistent understandings for the security tag, and improving communication efficiency.

The security granularity may be used to determine a range covered by the security tag, for example, a scenario covered by the security tag; or the security granularity may be used to determine a granularity to which the security tag belongs. For example, the security tag belongs to at least one of a user granularity, a device granularity, and a service granularity. Different granularities to which the security tag belongs may affect the range of the security tag, or affect a period of the security tag. In an example, the user granularity may correspond to a user, and the security granularity is used to declare a user identifier (ID), for example, an account related to an identity of the user, such as an SUPI. For another example, the device granularity may correspond to a device, and the security granularity is used to declare a device ID, for example, a permanent equipment identifier (PEI). Optionally, when the security granularity is the device granularity, the security granularity may be further used to declare a user ID. For another example, the service granularity may correspond to a service, and the security granularity is used to declare a service ID, for example, a session ID (session ID). Optionally, when the security granularity is the service granularity, the security granularity may be further used to declare at least one of a user ID or a device ID. For example, different security granularities may cover different scenarios. For example, the device granularity may be used to cover a security decision negotiation method in a device registration phase. For another example, the service granularity may be used to cover a security decision negotiation method in a service request phase. For another example, the user granularity may cover both a security decision negotiation method in a registration phase and a security decision negotiation method in a service request phase. In an example, different security granularities may correspond to different periods (or referred to as validity periods). If the security granularity is the user granularity, the security tag may correspond to a user ID. For example, even if a user uses different devices, if the user ID does not change, the security tag may not be updated. A key is generated for each user, and all data of the user is encrypted by using a same method. If the security granularity is the device granularity, it indicates that the security tag may need to be updated when a user replaces a device. If the security granularity is the service granularity, it indicates that different services may correspond to different security decisions. It may be understood that security granularities of the security requirement tag and the security decision tag may be the same, that is, the security decision may correspond to the security requirement. A range covered by the tag may be flexibly indicated by carrying the security granularity.

The authentication method may include at least one of authentication and key agreement (AKA), an identity-based signature (IBS), and a public key-based certificate. The encryption algorithm may include at least one of Show 3G, an advanced encryption standard (AES), a ZUC algorithm (ZUC), and a post-quantum encryption algorithm. The integrity protection algorithm may include at least one of Show 3G, AES, and ZUC. For the encryption key length and the integrity protection key length, the two pieces of information in the security requirement may be set to 0. The two pieces of information in the security capability may include a shortest key length and a longest key length that are supported by the capability provider. The security tag carries the encryption algorithm, the integrity protection algorithm, the encryption key length, and the integrity protection key length, so that the security tag can be compatible with a conventional security capability of a communication network, thereby ensuring compatibility of the security tag. In addition, it can be effectively ensured that a device corresponding to the conventional security capability of the communication network can still perform communication by using the encryption algorithm and the integrity protection algorithm, thereby effectively ensuring backward compatibility of the security tag.

The key capability may indicate whether a user is supported in participating in key generation. For example, a UP plane key may be generated with participation of the user. If a value of this field is set to 1, it may indicate that the user is supported in participating in key generation. If a value of this field is set to 0, it may indicate that the user is not supported in participating in key generation. The security tag carries the key capability, so that the user can autonomously participate in UP plane key generation, and user data can be protected.

The privacy protection may indicate at least one of a privacy protection algorithm and a privacy protection level. The privacy protection level may include at least one of ID protection, data protection, and behavior protection. The privacy protection algorithm may include at least one of differential privacy, anonymization, and homomorphic encryption. The ID protection may be understood as protecting an ID of a user. The data protection may be understood as that an ID is in plaintext, but generated data needs to be protected. The behavior protection may be understood as protecting behavior of a user in a network. The security tag carries the privacy protection, so that privacy protection for the user can be improved.

The trustworthiness attestation may indicate a trusted computing platform attached to a system. For example, the trusted computing platform includes at least one of a trusted platform module (TPM), a trusted cryptography module (TCM), a trusted platform control module (TPCM), a software guard extensions (SGX), a trusted execution environment (TEE), and a trustzone (trustzone). For example, a function of the trustworthiness attestation may include at least two dimensions: a capability of a device, and a capability of verifying a measurement result of another node and a capability of endorsing a verification result in addition to the trustworthiness attestation capability of the device. For example, when the requester needs the trustworthiness attestation, and the capability provider can provide a capability for the trustworthiness attestation, the capability provider and the requester may interact by using the capability, or the capability provider may perform verification on another node. By carrying the trustworthiness attestation, the security tag may indicate whether a related network element has a trusted hardware platform, and may provide remote trustworthiness attestation information.

The cross-operator may indicate a roaming form or mobile number portability. For example, the cross-operator may indicate cross-domain and cross-network scenarios. The roaming form may be understood as different charging in different operator networks. For example, UE needs to be re-authenticated. An existing 3GPP standard uses this method. Mobile number portability may be understood as that a same set of services is used in different operator networks, and UE does not need to be re-authenticated. The security tag carries the cross-operator, to support a unified credential (credential), and have a cross-operator authentication capability.

The distributed ledger may converge a future communication network and a distributed ledger. The distributed ledger may indicate a distributed ledger capability, for example, a capability about whether the distributed ledger is supported, and a capability level, including a capability of performing query, upload, and download as a client, a capability of calling and deploying a smart contract, a capability of verifying a transaction, a consensus capability, a storage capability, and the like. The security tag carries the distributed ledger, so that the communication network and the distributed ledger can be converged, and the communication network is fully combined with a blockchain, thereby improving security of the stored security tag.

Optionally, the security tag shown in this embodiment of this application may further include some reserved fields, and the reserved fields may be used to maintain forward compatibility of the security tag.

In an example, the security requirement may include an encryption algorithm, an encryption key length, an integrity protection algorithm, an integrity protection key length, an authentication method, a tag attribute, and a security granularity, and for example, is applicable to a lightweight device. In another example, the security requirement may include an encryption algorithm, an encryption key length, an integrity protection algorithm, an integrity protection key length, a tag type, and a distributed ledger. In another example, the security requirement includes encryption and integrity protection algorithms whose key lengths are greater than a third length, a post-quantum encryption algorithm, and a distributed ledger, and for example, is applicable to a device with a high computing capability. It may be understood that specific security functions required by different types of requesters are not listed one by one in this embodiment of this application.

Lengths and values of the security requirement, the security capability, and the security decision may be described as follows:

### Method A: a Length of Each Field is Fixed

In an example, lengths of all fields are the same. A length of each field shown in FIG. 4a to FIG. 4c may be n bits, where n is an integer greater than or equal to 1. The length of the field may vary based on a length of a field that needs to carry a largest amount of information in the security tag. For example, if a trustworthiness attestation field in the security tag needs to carry a largest amount of information, for example, include at least five types of information, a length of each field in the security tag may be 3 bits. For another example, if the encryption algorithm in the security tag needs to carry a largest amount of information, for example, include three types of information, a length of each field in the security tag may be 2 bits. It may be understood that, when a value of a field is 0, it may indicate that the security tag does not include information corresponding to the field. For example, when a value of a privacy protection field in the security requirement is 0, it may indicate that the requester does not need privacy protection. For another example, when a value of a trustworthiness attestation field in the security capability is 0, it may indicate that the capability provider cannot provide the trustworthiness attestation. For another example, when a value of a cross-operator field in the security decision is 0, it indicates that a security function determined through negotiation does not include the cross-operator.

In this embodiment of this application, because lengths of all fields are the same, the first network element can quickly parse the security requirement and the security capability, thereby improving efficiency of determining the security decision by the first network element.

In another example, lengths of at least two fields are different. For example, a tag attribute field may occupy 3 bits or 4 bits. For another example, a trustworthiness attestation field may occupy 3 bits, and another field may occupy 2 bits. In this embodiment of this application, lengths of at least two fields in the security tag may be different, so that signaling overheads of the security tag can be effectively reduced.

### Method B: a Length of Each Field May be Variable

In an example, lengths of all fields may be the same. Therefore, the first network element may learn of the length of each field based on a total length (for example, indicated by using a tag length) of the security tag and a total quantity of fields. It may be understood that information included in the security tag is usually known. In this embodiment of this application, a length of a field may be variable, and lengths of all fields are the same. Therefore, a length of the security tag is set more flexibly, and the first network element can quickly parse the security tag.

In another example, lengths of at least two fields are different. In this case, some fields may be added to the security tag, or information for indicating a length is added to each field, or information for indicating a length is added to a field whose length changes. In this embodiment of this application, a length of a field is variable, and lengths of at least two fields may be different. Therefore, a length of the security tag is set more flexibly, and signaling overheads can be further reduced.

### Method C: a Length of the Security Tag is Determined Based on a Quantity of Security Functions in the Security Tag

In an example, as shown in FIG. 4b, each type of information may occupy 1 bit. For example, a user granularity, a device granularity, a service granularity, AKA, IBS, Show 3G, AES, ZUC, and a post-quantum encryption algorithm each may occupy 1 bit. For example, the security requirement may include a first bitmap (bitmap), and each bit in the first bitmap may indicate whether a corresponding security function is required. For example, if a value of a corresponding bit is 1, it indicates that the requester requires a security function corresponding to the bit. If a value of a corresponding bit is 0, it indicates that the requester does not require a security function corresponding to the bit. For example, the security capability may include a second bitmap, and each bit in the second bitmap may indicate whether a corresponding security function can be provided. For example, if a value of a corresponding bit is 1, it indicates that the capability provider can provide (or support) a security function corresponding to the bit. If a value of a corresponding bit is 0, it indicates that the capability provider cannot provide a security function corresponding to the bit.

It may be understood that the foregoing description of the length of each field is merely an example, and should not be construed as a limitation on embodiments of this application. A length of the security requirement may be the same as or different from a length of the security capability. This is not limited in this embodiment of this application.

For the foregoing method A to method C, each field in the security tag may be used to carry a corresponding security function. For example, a value of the field may be used to carry an index of a security function corresponding to the field. Certainly, if the requester does not require a security function, for example, using a security algorithm A as an example below, a field corresponding to the security algorithm A in the security requirement may not carry an index of the security algorithm A. If the capability provider cannot provide a security algorithm or some security algorithms, for example, using a security algorithm B as an example below, a field corresponding to the security algorithm B in the security capability may not carry an index of the security algorithm B. For example, when the security tag does not include a security algorithm, a value of a field corresponding to the security algorithm may be 0. The foregoing method A to method C are applicable to the security requirement, the security capability, and the security decision.

Method D: The security requirement may include priority information of at least one of the following information: the encryption algorithm, the integrity protection algorithm, the authentication method, the key capability, the privacy protection, the trustworthiness attestation, the cross-operator, and the distributed ledger.

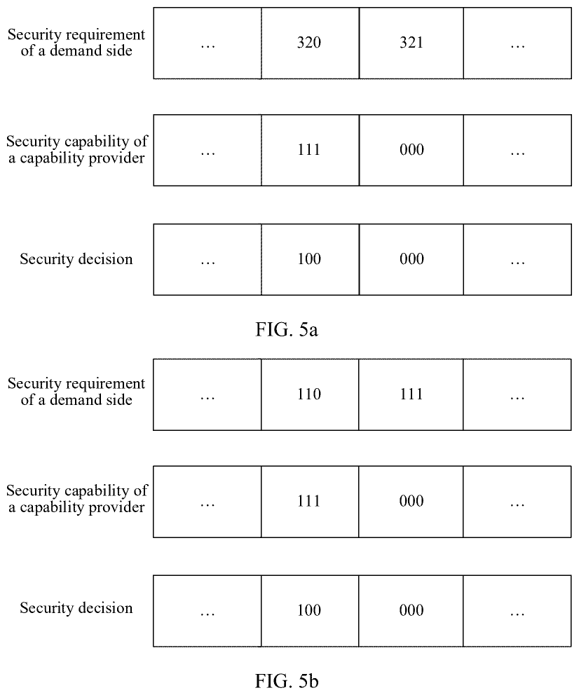

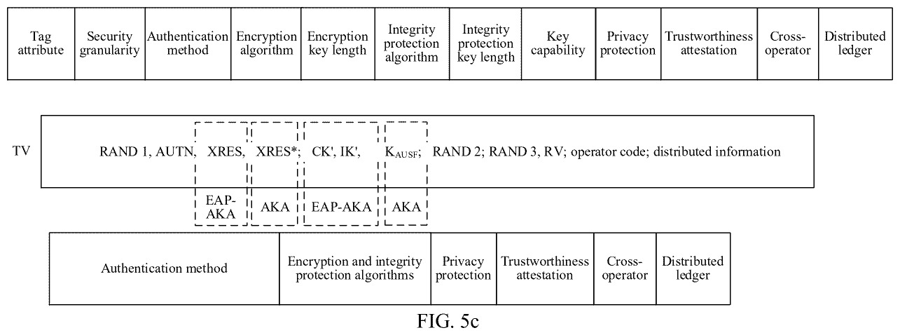

In an example, the security requirement may include priority information of at least one of the foregoing information. In this case, the length of the security requirement may be adaptively increased. For example, a tag bit corresponding to each security function (which may also be referred to as a field corresponding to each security function) is set to a priority. If a security function is not used, a tag bit corresponding to the security function is set to 0. FIG. 5a shows an example. For example, 320 in a security requirement shown in FIG. 5a may be understood as follows: In algorithms corresponding to a field to which 320 belongs, a priority of a first algorithm is 3, a priority of a second algorithm is 2, and a priority of a third algorithm is 0. Certainly, 320 shown herein is merely an example, and should not be understood as a limitation on embodiments of this application. 321 in the security requirement shown in FIG. 5a may be understood as follows: In algorithms corresponding to a field to which 321 belongs, a priority of a first algorithm is 3, a priority of a second algorithm is 2, and a priority of a third algorithm is 1. 111 in a security capability shown in FIG. 5a may be understood as that an algorithm corresponding to a field to which 111 belongs is supported by the capability provider; and 000 may be understood as that an algorithm corresponding to a field to which 000 belongs is not supported by the capability provider. In FIG. 5a, a sequence of algorithms carried in each field may be fixed, to ensure that the first network element can determine the security decision based on the security requirement and the security capability. As shown in FIG. 5a, a security algorithm in the security decision corresponds to a first algorithm with a highest priority in the security requirement.

The security requirement includes the priority information, so that the first network element can obtain, by using one security requirement, a security algorithm required by the requester, and efficiency is higher.

In another example, the priority information of the at least one of the foregoing information may be sent in an independent manner. That is, a security algorithm required in the security requirement is set to 1, and a security algorithm not required is set to 0. Then, a priority of a security algorithm whose field value is not 0 in the security requirement is indicated by using other information. FIG. 5b shows an example. 110 in a security requirement shown in FIG. 5b may be understood as that priorities of a first algorithm and a second algorithm in algorithms corresponding to a field to which 110 belongs are the same and are both 1, and 111 may be understood as that priorities of algorithms corresponding to a field to which 111 belongs are not distinguished. For descriptions of 111 and 000 in a security capability shown in FIG. 5b and descriptions of a security decision shown in FIG. 5b, refer to the description of the security requirement and FIG. 5a. Details are not described herein again. The priority information is independently sent, so that signaling overheads of the security requirement can be effectively reduced.

It may be understood that the foregoing descriptions of the security requirement, the security capability, and the security decision are merely an example. In specific implementation, the requester and the capability provider only need to agree on a format of the tag, so that the first network element can correctly parse the security requirement and the security capability.

A method for Determining the Security Decision May be Described as Follows

In an example, the first network element determines a value of a first bit in the security decision based on an operation or mapping result for a value of a first bit in the security requirement and a value of a first bit in the security capability. If a value 1 of each bit indicates that the security tag supports a security function in the corresponding bit, and a value 0 of each bit indicates that the security tag does not support a security function in the corresponding bit, for descriptions of the operation or mapping result, refer to Table 2. It can be learned from Table 2 that, when the requester needs a security function and the capability provider can provide the security function, a corresponding bit of the security decision is 1, indicating that the requester and the capability provider can use the security function for communication. Similarly, if at least one of the requester or the capability provider does not support a security function, a corresponding bit of the security decision is 0, indicating that the requester and the capability provider cannot use the security function for communication.

TABLE 2

| Value of a first bit in | Value of a first bit in | Value of a first bit in |
|---|---|---|
| a security requirement | a security capability | a security tag |
| 1 | 1 | 1 |
| 1 | 0 | 0 |
| 0 | 1 | 0 |
| 0 | 0 | 0 |

In this implementation, the first network element may determine the security decision based on a value of a corresponding bit. This manner is simple, and reduces workload of the first network element.

It should be noted that, that the first network element determines the security decision based on the value of the corresponding bit is merely an example. For example, when lengths of the security requirement and the security capability are the same (for example, in the foregoing method A and method C), the security decision may be determined based on the value of the corresponding bit. When lengths of the security requirement and the security capability may be different (for example, in the foregoing method B), the first network element may determine the security decision with reference to a length of each field and content carried in each field.

In another example, the first network element determines the security decision based on priority information in the security requirement and the security capability.

A non-zero tag bit is determined by using a priority list. The priority list may be formulated by an operator, or may be specified by a network element such as UE or an AF. The priority list shown herein may be understood as a format of a priority list included in the security tag. If the format of the priority list is formulated by the operator, the format is unified, and all network elements can correctly parse the security tag including the priority list. If the format of the priority list is negotiated by both communication parties, flexibility and diversity of the priority list can be effectively improved.

In another example, the first network element may determine the security decision based on the security requirement, the priority information, and the security capability. In this case, the priority information and the security requirement may be independent content. For a manner of determining the security decision by the first network element, refer to the foregoing manner. Details are not described herein again.

In this embodiment of this application, the first network element determines the security decision by using the priority information, so that accuracy of the security decision can be improved.

Generally, the security decision may be corresponding to the security requirement. For example, if an algorithm in the security requirement of the requester is unique, and the algorithm is not unique in the security capability of the capability provider, security decisions determined based on the security requirement and the security capability may be the same. For example, an encryption algorithm required in the security requirement is AES, and encryption algorithms that can be provided in the security capability include at least two of the following: Show 3G, AES, ZUC, a post-quantum encryption algorithm, and the like. In this case, an encryption algorithm in the security decision determined by the first network element based on the encryption algorithm requirement in the security requirement and the encryption algorithms that can be provided in the security capability may be AES. For another example, privacy protection required in the security requirement is differential privacy protection, and privacy protection that can be provided in the security capability includes differential privacy protection, anonymization privacy protection, and homomorphic encryption privacy protection. In this case, privacy protection in the security decision may be differential privacy protection. Certainly, if a type of security algorithm required by the requester is not unique, and the capability provider has a limited capability for the type of security algorithm, the security decision corresponds to the security requirement and the security capability.

302: The first network element sends a message including the security decision.

In this embodiment of this application, the first network element may send the message including the security decision to another network element. Alternatively, the security decision may be uploaded to the distributed ledger, so that another network element may download the security decision from the distributed ledger. The another network element may be any network element other than the first network element. This is not limited in this embodiment of this application.

For example, the first network element may send the message including the security decision to a UDM. Correspondingly, the UDM receives the message including the security decision, and determines a trustworthiness vector (TV) based on the security decision. The trustworthiness vector may include all parameters related to the security algorithm, and corresponds to the security decision. When a network element (such as a network function) requests a parameter required by the security algorithm from the UDM, the UDM further generates a required security vector based on the TV and sends the required security vector to the network element. FIG. 5c shows an example of a trustworthiness vector. In FIG. 5c, a random number (RAND) 1, an authentication token (AUTN), an expected response (XRES), and XRES* may be understood as authentication vectors, and correspond to the authentication method. XRES may correspond to EAP-AKA, and XRES* may correspond to AKA. A crypto key (CK′), an integrity key (IK′), and K_{AUSF} may correspond to the encryption and integrity protection algorithms. CK′ and IK′ correspond to EAP-AKA, and K_{AUSF} corresponds to AKA. A RAND 2 may correspond to the privacy protection, a RAND 3 and a reference value (RV) may correspond to the trustworthiness attestation, operator code may correspond to the cross-operator, and distributed information corresponds to the distributed ledger.

It may be understood that the security decision may have a specific validity period. Within the validity period, if a network element needs to use the security decision, the network element may request the security decision from a network element (such as the first network element or the UDM) that stores the security decision, or download the security decision from the distributed ledger. If the security decision has expired, when a network element needs to use the security decision, the network element needs to re-determine the security decision according to the method provided in this embodiment of this application.

According to the security decision negotiation method provided in this embodiment of this application, the first network element may effectively formulate the security decision with reference to the security requirement of the requester and the security capability of the capability provider, so that not only flexibility of security decision negotiation is improved, but also the requester and the capability provider can determine the security decision in a negotiation manner. This improves participation of the requester, and ensures effectiveness of the security decision. For the security decision negotiation method shown in FIG. 2, in FIG. 2, only a core network device can make a security decision, only an encryption algorithm and an integrity protection algorithm can be set, and no more security algorithms can be involved. However, in the method provided in this embodiment of this application, not only more types of security functions are involved, but also the requester can more flexibly participate in a security decision negotiation procedure, thereby ensuring different security requirements of the requester in different scenarios.

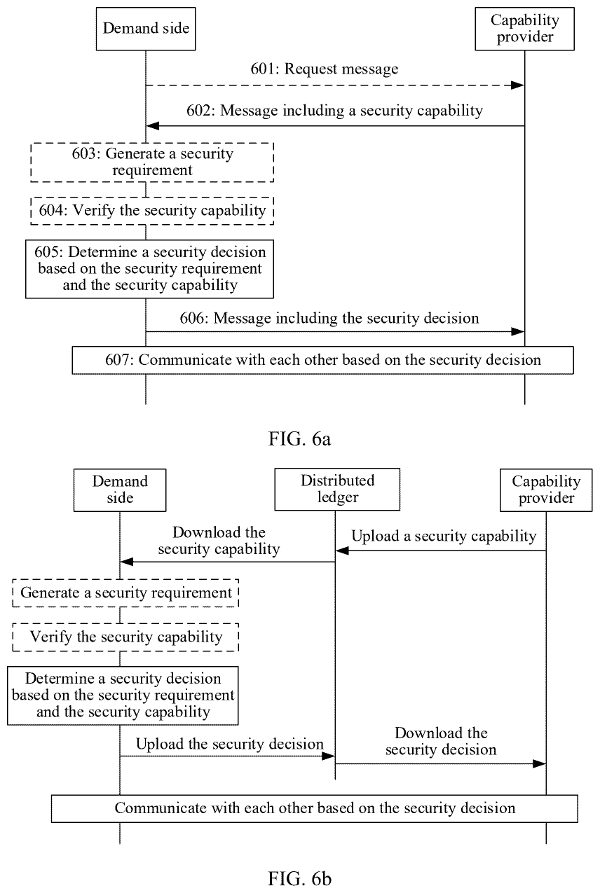

FIG. 6a is a schematic flowchart of a security decision negotiation method according to an embodiment of this application. A capability provider and a requester shown in FIG. 6a each may be any device, network element, or network function in a network. This is not limited in this embodiment of this application. As shown in FIG. 6a, the method includes the following steps.

602: The capability provider sends a message including a security capability. Correspondingly, the requester receives the message including the security capability.

In a possible implementation, the capability provider may send the message including the security capability in a broadcast manner. The message including the security capability is sent in the broadcast manner, so that more requesters can simultaneously obtain the security capability of the capability provider, and the capability provider can determine a security decision by simultaneously negotiating with a plurality of requesters, thereby effectively improving communication efficiency. In addition, generally, a capability of the capability provider may be fixed. Therefore, when different capability providers send security capabilities in a broadcast manner, a requester can flexibly select different capability providers for communication based on a security requirement of the requester. Certainly, in this implementation, the capability provider needs to have a broadcast capability.

In another possible implementation, the capability provider may send the message including the security capability to the requester in a unicast manner.

In an example, the capability provider may send the message including the security capability to the requester at a fixed frequency or period; or the capability provider may send the message including the security capability to the requester when the security capability is updated; or the capability provider may send the message including the security capability to the requester when the capability provider is powered on; or the capability provider may send the message including the security capability to the requester when a system is updated. The capability provider actively sends the message including the security capability to the requester, so that the requester can obtain the security capability of the capability provider in time, thereby updating a security decision in time, and improving reliability of communication between the capability provider and the requester. It may be understood that the foregoing occasion on which the capability provider sends the message including the security capability is also applicable to an occasion on which the capability provider generates the security capability.

In another example, before the capability provider sends the message including the security capability, as shown in step 601 in FIG. 6a, the requester sends a request message to the capability provider, where the request message is used to request the security capability of the capability provider. Correspondingly, the capability provider receives the request message, and sends the message including the security capability to the requester. The requester sends the request message, so that the capability provider sends the security capability of the capability provider to the requester, and the capability provider may send the security capability to different requesters, thereby improving efficiency of security decision negotiation.

In another possible implementation, as shown in FIG. 6b, the capability provider may upload the security capability to a distributed ledger. Correspondingly, the requester may download the security capability from the distributed ledger. Both the capability provider and the requester may be understood as distributed ledger nodes. Therefore, both the capability provider and the requester may upload related information or download related information by using the distributed ledger. The related information shown herein includes the security capability, the security requirement, and the security decision shown in embodiments of this application. The security capability is uploaded to the distributed ledger, so that when using the security capability, the requester can directly download the security capability from the distributed ledger. In this way, not only a communication network and a distributed ledger technology are effectively converged, but also security of a security tag is improved.

It may be understood that before the capability provider sends the security capability, the capability provider may generate the security capability based on the structure shown in FIG. 4b. Certainly, the structure of the security capability shown in FIG. 4b is merely an example, and should not be construed as a limitation on embodiments of this application. For example, the capability provider may traverse security functions of the capability provider, to generate the security capability, and declare all security functions that can be provided by the capability provider. In a possible implementation, before generating the security capability, the capability provider may further set a manner of generating the security capability. In an example, the capability provider may set automatic generation of the security capability. For example, the security capability is automatically generated based on the foregoing occasion for sending the message including the security capability. For another example, the capability provider automatically senses an application scenario, and sets the security capability according to a preset rule. In another example, the capability provider may manually generate the security capability. For example, an operator sets the security capability by using a related application (APP).

In a possible implementation, the method shown in FIG. 6a further includes step 603.

603: The requester generates a security requirement.

It may be understood that before determining a security decision, the requester may generate the security requirement based on the structure shown in FIG. 4a, so that the requester can quickly and conveniently determine the security decision. Certainly, the requester may not generate the security requirement, but determine a security decision based on a requirement and a security capability of the requester.

In an example, the requester may automatically generate the security requirement. For example, the requester automatically senses an application scenario, and sets the security requirement according to a specific rule. For example, the requester may generate the security requirement according to at least one of the following rules: (1) a network status of the requester, where the network status may include a home location or a roaming location; (2) a network in which the requester is located, for example, a cellular network or a Wi-Fi network; or (3) a device type of the requester, for example, a vehicle, an IoT device, or a mobile phone. According to the foregoing different rules, the requester may have different requirements, so that different security requirements may be generated. In another example, the requester may manually generate the security requirement. For example, a user sets the security requirement by using an APP.

It may be understood that a sequence of step 603 and step 601 or step 602 is not limited in this embodiment of this application. A location of step 603 shown in FIG. 6a is merely an example, and should not be construed as a limitation on this embodiment of this application.

In a possible implementation, the method shown in FIG. 6a further includes step 604.

604: The requester verifies the security capability.

For example, the requester may verify whether the security capability is trusted. If the security capability is trusted, the requester may perform step 605. For example, the capability provider may sign the security capability by using a private key, or encrypt the security capability by using an encryption method. Correspondingly, the requester may verify the security capability by using a public key or a decryption method. If the security capability is untrusted, the requester may discard the security capability, or request a security capability from the capability provider again; or the requester may return a failure message, where the failure message indicates that the security capability verification fails, so that the capability provider generates a security capability again. This is not limited in this embodiment of this application. It may be understood that, after verification performed by the requester on the security capability fails a plurality of times, the requester may stop the security decision negotiation procedure. The requester verifies the security capability, so that trustworthiness of determining the security decision can be effectively ensured, and the trustworthiness of determining the security decision can be improved.

605: The requester determines a security decision based on the security requirement and the security capability.

It may be understood that for specific descriptions of determining the security decision by the requester, refer to FIG. 3. Details are not described herein again.

606: The requester sends a message including the security decision. Correspondingly, the capability provider receives the message including the security decision.

In a possible implementation, the requester may send the security decision by using a unicast message.

In another possible implementation, as shown in FIG. 6b, the requester may upload the security decision to the distributed ledger. Correspondingly, the capability provider downloads the security decision from the distributed ledger. It may be understood that for specific descriptions of related steps shown in FIG. 6b, refer to FIG. 6a. Details are not described again in this embodiment of this application.

607: The requester and the capability provider communicate with each other based on the security decision.

For example, the requester and the capability provider may set a security function based on the security decision, to perform encryption and integrity protection on subsequent signaling and data by using the negotiated security function in encryption and integrity protection performed after authentication is completed. Alternatively, if the security decision includes a trustworthiness measurement capability, a trustworthiness measurement procedure for the capability provider and the requester may be added in an authentication procedure. Examples in which the requester and the capability provider perform communication based on the security decision are not listed one by one in this embodiment of this application.

In this embodiment of this application, the requester obtains the security capability of the capability provider, to determine the security decision with reference to the security requirement of the requester and the security capability of the capability provider. This effectively ensures that the requester can autonomously participate in a security decision negotiation procedure, and further makes formulation of the security decision more proper and effective.

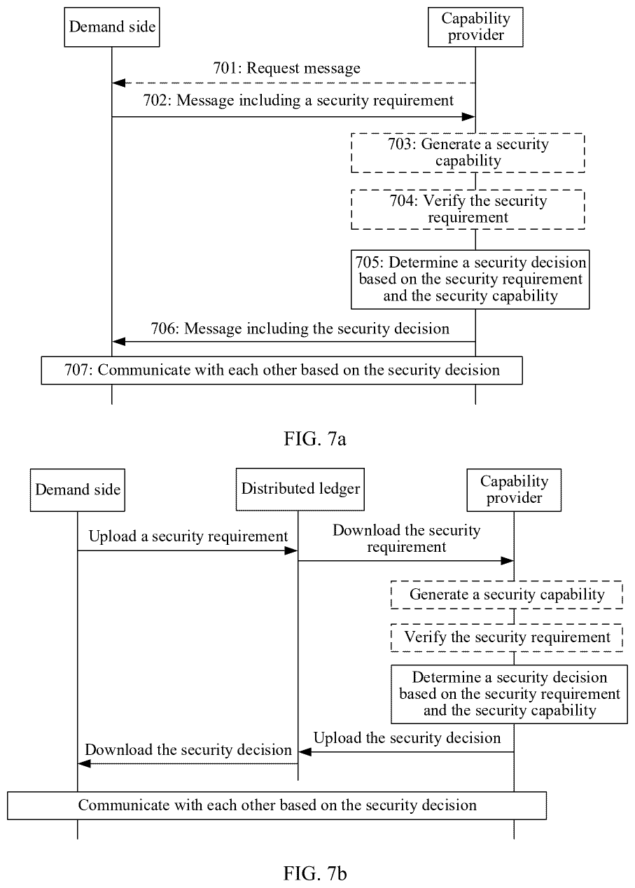

FIG. 7a is a schematic flowchart of a security decision negotiation method according to an embodiment of this application. A capability provider and a requester shown in FIG. 7a each may be any device, network element, or network function in a network. This is not limited in this embodiment of this application. As shown in FIG. 7a, the method includes the following steps.

702: The requester sends a message including a security requirement. Correspondingly, the capability provider receives the message including the security requirement.

In a possible implementation, the requester may send the message including the security requirement in a broadcast manner. The message including the security requirement is sent in the broadcast manner, so that more capability providers can simultaneously obtain the security requirement of the requester, and the requester can determine a security decision by simultaneously negotiating with a plurality of capability providers. In addition, a plurality of requesters can simultaneously negotiate with one capability provider to make a security decision, thereby effectively improving communication efficiency. Certainly, in this implementation, the requester needs to have a broadcast capability. It may be understood that when the requester sends the security requirement in the broadcast manner, a plurality of capability providers may simultaneously receive the security requirement, to determine a plurality of security decisions. Therefore, after receiving the plurality of security decisions, the requester may determine one security decision from the plurality of security decisions, to communicate with a capability provider corresponding to the determined security decision, thereby effectively ensuring implementability of the security requirement of the requester.

In another possible implementation, the requester may send the message including the security requirement to the capability provider in a unicast manner.

In an example, the requester may send the message including the security requirement to the capability provider at a fixed frequency or period; or the requester may send the message including the security requirement to the capability provider when the security requirement is updated; or the requester may send the message including the security requirement to the capability provider when the requester is powered on; or the requester may send the message including the security requirement to the capability provider when a system is updated. The requester actively sends the message including the security requirement to the capability provider, so that the capability provider can obtain the security requirement of the requester in time, thereby updating a security decision in time, and improving reliability of communication between the capability provider and the requester. It may be understood that the foregoing occasion on which the requester sends the message including the security requirement is also applicable to an occasion on which the requester generates the security requirement.

In another example, before the requester sends the message including the security requirement, as shown in step 701 in FIG. 7a, the capability provider sends a request message to the requester, where the request message is used to request the security requirement of the requester. Correspondingly, the requester receives the request message, and sends the message including the security requirement to the capability provider. The capability provider sends the request message, so that the requester sends the security requirement of the requester to the capability provider. In addition, the requester may send the security requirement to a plurality of capability providers at the same time, thereby improving efficiency of security decision negotiation.

In another possible implementation, as shown in FIG. 7b, the requester may upload the security requirement to a distributed ledger. Correspondingly, the capability provider may download the security requirement from the distributed ledger. The security requirement is uploaded to the distributed ledger, so that when using the security requirement, the capability provider can directly download the security requirement from the distributed ledger. In this way, not only a communication network and a distributed ledger technology are effectively converged, but also security of a security tag is improved.

It may be understood that before the requester sends the security requirement, the requester may generate the security requirement based on the structure shown in FIG. 4a. Certainly, the structure of the security requirement shown in FIG. 4a is merely an example, and should not be construed as a limitation on embodiments of this application. In a possible implementation, before generating the security requirement, the requester may further set a manner of generating the security requirement. For specific descriptions of a manner of setting the security requirement, refer to FIG. 6a. Details are not described herein again.

In a possible implementation, the method shown in FIG. 7a further includes step 703.

703: The capability provider generates a security capability.

Before determining a security decision, the capability provider may generate the security capability based on the structure shown in FIG. 4b, so that the capability provider can quickly and conveniently determine the security decision. Certainly, the capability provider may not generate the security capability, but determine a security decision based on a capability and a security requirement of the capability provider. In an example, the capability provider may automatically generate the security capability. For example, the capability provider automatically senses an application scenario, and sets the security capability according to a specific rule. In another example, the capability provider may manually generate the security capability. For example, a user sets the security capability by using an APP. For a manner of setting the security capability, refer to FIG. 6a. Details are not described herein again. It may be understood that a sequence of step 703 and step 701 or step 702 is not limited in this embodiment of this application. A location of step 703 shown in FIG. 7a is merely an example, and should not be construed as a limitation on this embodiment of this application.

704: The capability provider verifies the security requirement.

For example, the capability provider may verify whether the security requirement is trusted. If the security requirement is trusted, the capability provider may perform step 705. If the security capability is untrusted, the capability provider may discard the security requirement, or request a security requirement from the requester again; or the capability provider may return a failure message, where the failure message indicates that the security requirement verification fails, so that the requester generates a security requirement again. This is not limited in this embodiment of this application. It may be understood that, after verification performed by the capability provider on the security requirement fails a plurality of times, the capability provider may stop the security decision negotiation procedure. The capability provider verifies the security requirement, so that trustworthiness of determining the security decision can be effectively ensured, and the trustworthiness of determining the security decision can be improved. For specific descriptions of step 704, adaptively refer to step 604 shown in FIG. 6a.

705: The capability provider determines a security decision based on the security requirement and the security capability.

It may be understood that for specific descriptions of determining the security decision by the requester, refer to FIG. 3. Details are not described herein again.

706: The capability provider sends a message including the security decision. Correspondingly, the requester receives the message including the security decision.

In a possible implementation, the capability provider may send the security decision by using a unicast message.

In another possible implementation, as shown in FIG. 7b, the capability provider may upload the security decision to the distributed ledger. Correspondingly, the requester downloads the security decision from the distributed ledger. It may be understood that for specific descriptions of related steps shown in FIG. 7b, refer to FIG. 7a. Details are not described again in this embodiment of this application.

707: The requester and the capability provider communicate with each other based on the security decision.

It may be understood that for a part that is not described in detail in the method shown in FIG. 7a, refer to FIG. 3 or FIG. 6a.

In this embodiment of this application, the capability provider obtains the security requirement of the requester, to determine the security decision with reference to the security requirement of the requester. This ensures that formulation of the security decision is more proper, and makes a security decision negotiation procedure more flexible.

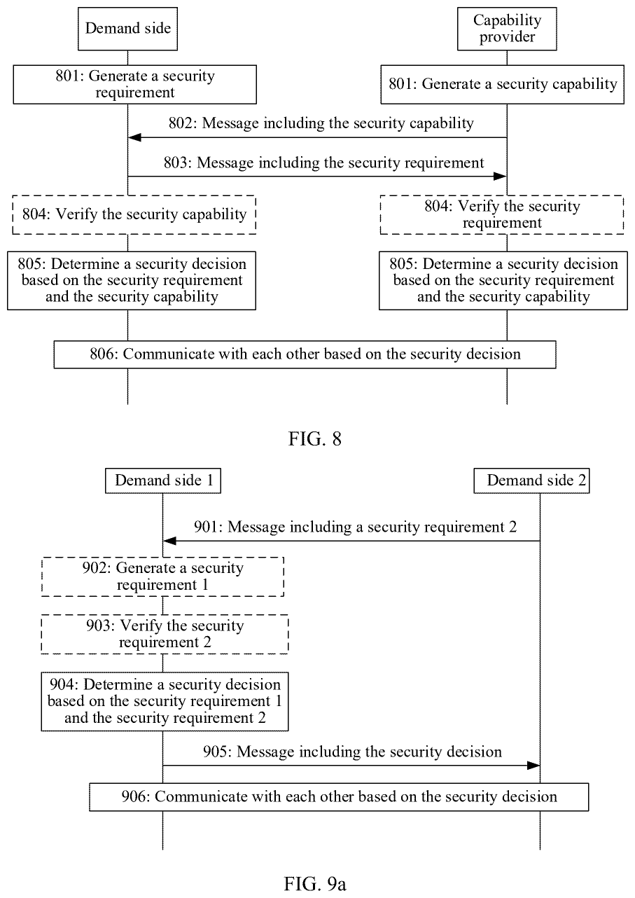

FIG. 8 is a schematic flowchart of a security decision negotiation method according to an embodiment of this application. A capability provider and a requester shown in FIG. 8 each may be any device, network element, or network function in a network. This is not limited in this embodiment of this application. As shown in FIG. 8, the method includes the following steps.

801: The requester generates a security requirement, and the capability provider generates a security capability.

For example, the capability provider may generate the security capability based on the structure shown in FIG. 4b, and the requester may generate the security requirement based on the structure shown in FIG. 4a. For a manner or an occasion of generating the security capability and the security requirement, refer to FIG. 3, FIG. 6a, and FIG. 7a. Details are not described herein again. A sequence in which the requester generates the security requirement and the capability provider generates the security capability is not limited in this embodiment of this application.

802: The capability provider sends a message including the security capability. Correspondingly, the requester receives the message including the security capability.

803: The requester sends a message including the security requirement. Correspondingly, the capability provider receives the message including the security requirement.

It may be understood that a sequence of step 802 and step 803 is not limited in this embodiment of this application.

804: The requester verifies the security capability, and the capability provider verifies the security requirement.

For example, after receiving the security capability, the requester may verify whether the security capability is trusted, and after receiving the security requirement, the capability provider may verify whether the security requirement is trusted. A sequence in which the requester verifies the security capability and the capability provider verifies the security requirement is not limited in this embodiment of this application.

805: The requester determines a security decision based on the security requirement and the security capability, and the capability provider determines a security decision based on the security requirement and the security capability.

A sequence in which the requester determines the security decision and the capability provider determines the security decision is not limited in this embodiment of this application. For a method for determining the security decision, refer to FIG. 3. Details are not described herein again.

806: The requester and the capability provider communicate with each other based on the security decision.

In this embodiment of this application, the requester sends the security requirement to the capability provider, and the capability provider sends the security capability to the requester, so that the requester and the capability provider each may determine the security decision locally. This not only reduces signaling overheads, but also ensures that the security decision is formulated more properly, so that a security decision negotiation procedure is more flexible.

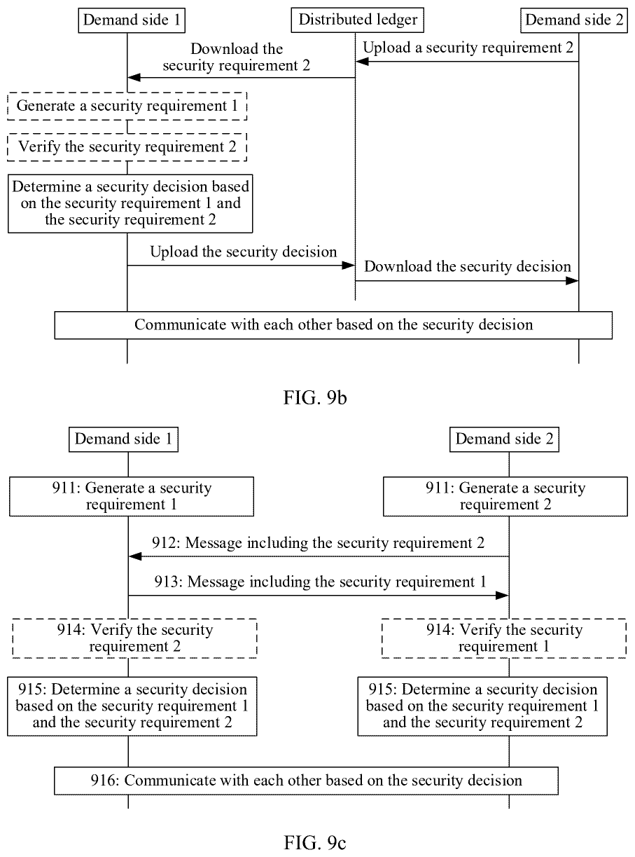

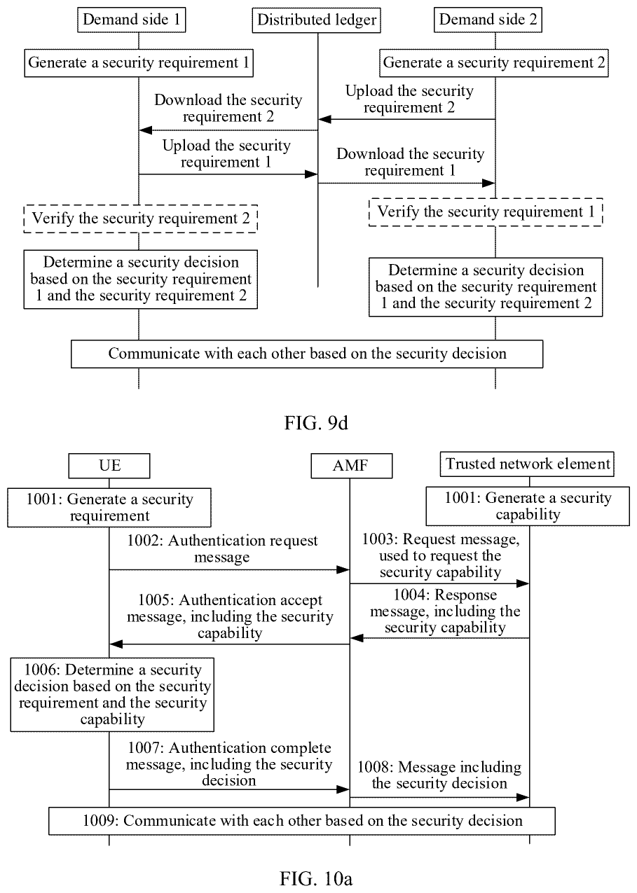

FIG. 9a is a schematic flowchart of a security decision negotiation method according to an embodiment of this application. This embodiment of this application provides a security decision negotiation method in which both communication parties provide security requirements of the communication parties. A security requirement of a requester actually also includes a security capability of the requester, because both communication parties can support these security algorithms when providing the security requirements of the communication parties. Therefore, if both communication parties are requesters, both communication parties may provide the security requirements. A security decision negotiation procedure is shown in FIG. 9a. In other words, the method may relate to two requesters, for example, a requester 1 and a requester 2 shown in FIG. 9a. The requester 1 and the requester 2 each may be any terminal device, IoT device, network function, or the like. This is not limited in this embodiment of this application. For example, both the requester 1 and the requester 2 may be D2D devices, or both the requester 1 and the requester 2 may be vehicles in V2X. For example, both the requester 1 and the requester 2 may be network functions, base stations, or the like. As shown in FIG. 9a, the method includes the following steps.

901: The requester 2 sends a message including a security requirement 2. Correspondingly, the requester 1 receives the message including the security requirement 2.

It may be understood that before the requester 2 sends the message including the security requirement 2, the requester 2 may further generate the security requirement 2 based on the structure shown in FIG. 4a. Certainly, the structure of the security requirement shown in FIG. 4b is merely an example, and should not be construed as a limitation on embodiments of this application.

In a possible implementation, the requester 2 may actively send the message including the security requirement 2 to the requester 1. For descriptions of actively sending the security requirement 2 by the requester 2, refer to the foregoing occasion on which the capability provider sends the security capability, or refer to the foregoing occasion on which the requester sends the security requirement. Details are not described herein again.

In another possible implementation, the requester 1 may send a request message to the requester 2. Correspondingly, the requester 2 receives the request message. Then, the message including the security requirement 2 is sent to the requester 1 based on the request message. For specific descriptions of the request message, refer to the foregoing description. Details are not described herein again.

In a possible implementation, as shown in FIG. 9b, the requester 2 may upload the security requirement 2 to a distributed ledger. Correspondingly, the requester 1 may download the security requirement 2 from the distributed ledger.

In a possible implementation, the method shown in FIG. 9a further includes step 902.

902: The requester 1 generates a security requirement 1.

In a possible implementation, the method shown in FIG. 9a further includes step 903.

903: The requester 1 verifies the security requirement 2.

904: The requester 1 determines a security decision based on the security requirement 1 and the security requirement 2.

905: The requester 1 sends a message including the security decision. Correspondingly, the requester 2 receives the message including the security decision.

In a possible implementation, as shown in FIG. 9b, the requester 1 may upload the security decision to the distributed ledger. Correspondingly, the requester 2 may download the security decision from the distributed ledger. It may be understood that for specific descriptions of related steps shown in FIG. 9b, refer to FIG. 9a. Details are not described again in this embodiment of this application.

906: The requester 1 and the requester 2 communicate with each other based on the security decision.

In this embodiment of this application, two requesters respectively generate security requirements, so that one party determines a security decision based on a security requirement of the party and a security requirement of the other party. This not only ensures that the two requesters can communicate with each other based on the security decision, but also ensures that the security decision is formulated more properly, so that a security decision negotiation procedure is more flexible.

FIG. 9c is a schematic flowchart of a security decision negotiation method according to an embodiment of this application. As shown in FIG. 9c, the method includes the following steps.

911: The requester 1 generates a security requirement 1, and the requester 2 generates a security requirement 2.

For example, both the requester 1 and the requester 2 may generate a security requirement based on structure shown in FIG. 4a. A sequence in which the requester 1 generates the security requirement 1 and the requester 2 generates the security requirement 2 is not limited in this embodiment of this application.

912: The requester 2 sends a message including the security requirement 2. Correspondingly, the requester 1 receives the message including the security requirement 2.

In a possible implementation, as shown in FIG. 9d, the requester 2 may upload the security requirement 2 to a distributed ledger. Correspondingly, the requester 1 may download the security requirement 2 from the distributed ledger.

913: The requester 1 sends a message including the security requirement 1. Correspondingly, the requester 2 receives the message including the security requirement 1.

In a possible implementation, as shown in FIG. 9d, the requester 1 may upload the security requirement 1 to the distributed ledger. Correspondingly, the requester 2 may download the security requirement 1 from the distributed ledger. For specific descriptions of FIG. 9d, refer to FIG. 9c. Details are not described herein.

It may be understood that a sequence of step 912 and step 913 is not limited in this embodiment of this application.

In a possible implementation, FIG. 9c may further include step 914.

914: The requester 1 verifies the security requirement 2, and the requester 2 verifies the security requirement 1.

915: The requester 1 determines a security decision based on the security requirement 1 and the security requirement 2, and the requester 2 determines a security decision based on the security requirement 1 and the security requirement 2.

916: The requester 1 and the requester 2 communicate with each other based on the security decision.

It may be understood that for specific descriptions of FIG. 9c, refer to FIG. 3, FIG. 8, FIG. 9a, and the like. Details are not described herein again.

In this embodiment of this application, two requesters respectively generate security requirements, so that each party determines a security decision based on a security requirement of the party and a security requirement of the other party. This not only ensures that the two requesters can communicate with each other based on the security decision, but also ensures that the security decision is formulated more properly, so that a security decision negotiation procedure is more flexible.

It should be noted that in the methods shown in FIG. 6a, FIG. 6b, FIG. 7a, FIG. 7b, FIG. 8, and FIG. 9a to FIG. 9d, the capability provider and the requester may be different terminal devices; or the capability provider and the requester may be different network functions; or the requester is a terminal device, and the capability provider is a core network element. The requester and the capability provider may directly communicate with each other during interaction, or interaction between the requester and the capability provider may be implemented by using a forwarding network element. This is not limited in embodiments of this application.

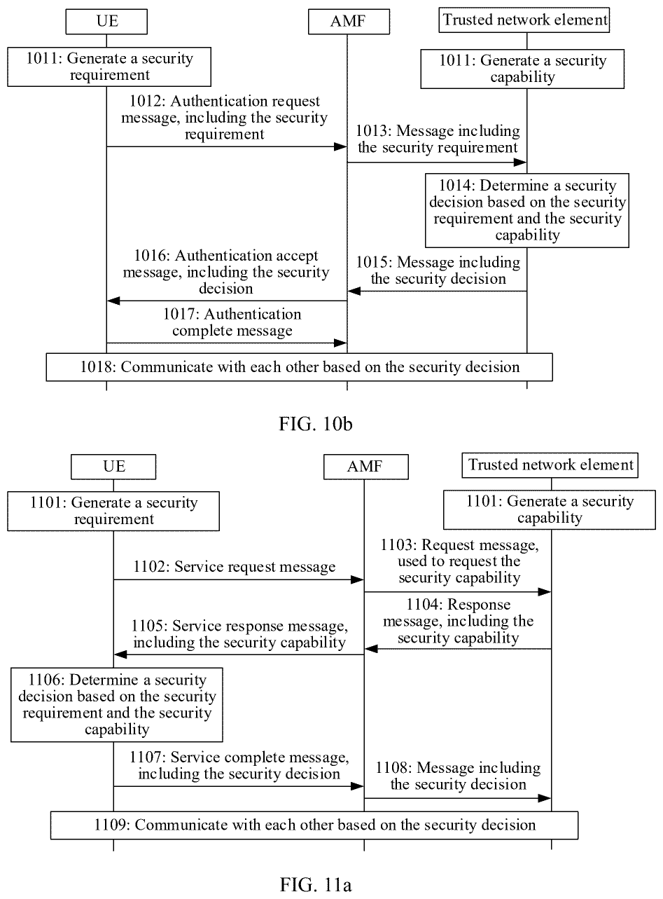

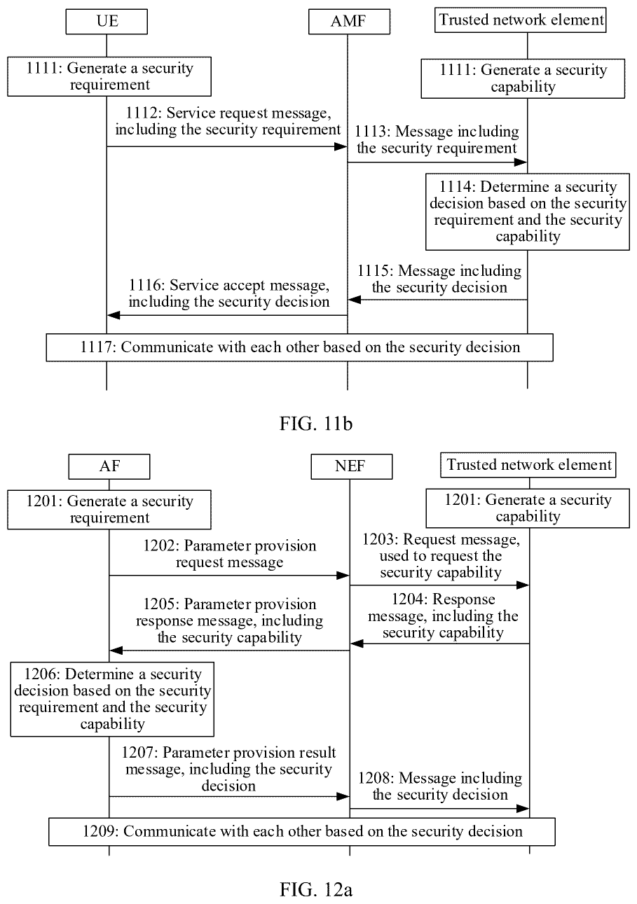

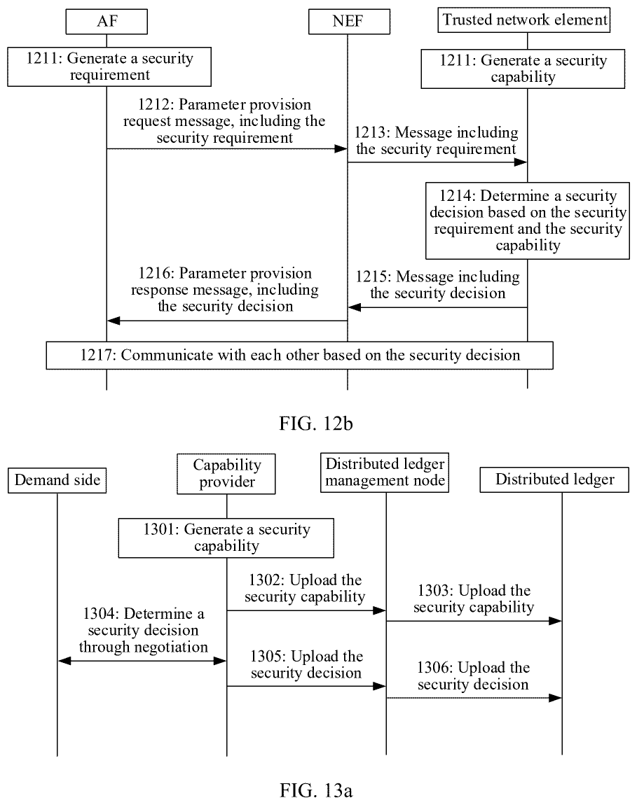

The following describes the security decision negotiation method provided in embodiments of this application with reference to different scenarios and devices. For descriptions of beneficial effects of FIG. 10a, FIG. 10b, FIG. 11a, FIG. 11b, FIG. 12a, and FIG. 12b, refer to the foregoing description.

FIG. 10a and FIG. 10b are schematic flowcharts of security decision negotiation methods according to an embodiment of this application. In FIG. 10a and FIG. 10b, a trusted network element may be used as an independent network function and exist in a core network. Therefore, it can be learned from the communication system shown in FIG. 1 that when UE needs to interact with a network element in the core network, a related message needs to be forwarded through an AMF. The AMF may forward the message in a transparent transmission manner or a reproduction manner. This is not limited in this embodiment of this application. In the security decision negotiation method, a security granularity of a security tag may be a device granularity. Therefore, a security decision negotiation procedure may be combined with a registration procedure of the UE, thereby improving efficiency of the registration procedure and the security decision negotiation procedure. Certainly, the method shown in this embodiment of this application may also be applied to a user granularity.

As shown in FIG. 10a, the security decision negotiation method includes the following steps.

1001: The UE generates a security requirement, and the trusted network element generates a security capability.

It may be understood that the UE may generate the security requirement based on a setting, and the trusted network element may traverse and query a security resource pool of a core network to generate a security capability of the core network. For specific descriptions of generating the security requirement by the UE based on the setting, refer to the foregoing description. Details are not described herein again.

1002: The UE sends a registration request (registration request) message to the AMF. Correspondingly, the AMF receives the registration request message.

1003: The AMF sends a request message to the trusted network element, where the request message is used to request the security capability. Correspondingly, the trusted network element receives the request message.

The request message may also be referred to as a security tag request message, a security tag provide request (security tag provide request) message, a security capability request message, or the like. This is not limited in this embodiment of this application. The request message may be further understood as being used to request the trusted network element to provide the security capability, or being used to request the trusted network element to provide the security capability of the core network.

1004: The trusted network element sends a response message to the AMF, where the response message includes the security capability. Correspondingly, the AMF receives the response message.

The response message may also be referred to as a security tag response message, a security tag provide response (security tag provide response) message, a security capability response message, or the like. This is not limited in this embodiment of this application.

1005: The AMF sends a registration accept (registration accept) message to the UE, where the registration accept message includes the security capability. Correspondingly, the UE receives the registration accept message.

In a possible implementation, if both the UE and the trusted network element use a distributed ledger, the trusted network element may upload the security capability to the distributed ledger, and the UE may download the security capability from the distributed ledger. For descriptions of the distributed ledger, refer to the foregoing related embodiments. Details are not described herein again.

In a possible implementation, after obtaining the security capability, the UE may further verify whether the security capability is trusted, and perform step 1006 if the security capability is trusted. For related descriptions of verifying the security capability by the UE, refer to the foregoing description. Details are not described herein again.

1006: The UE determines a security decision based on the security requirement and the security capability.

1007: The UE sends a registration complete (registration complete) message to the AMF, where the registration complete message includes the security decision. Correspondingly, the AMF receives the registration complete message.

1008: The AMF sends a message including the security decision to the trusted network element. Correspondingly, the trusted network element receives the message including the security decision.

The message including the security decision may also be referred to as a tag provide message, a security tag provide (security tag provide) message, or the like. This is not limited in this embodiment of this application.

1009: The UE and the trusted network element communicate with each other based on the security decision.

FIG. 10a is shown by using an example in which the UE determines the security decision, and FIG. 10b is described by using an example in which the trusted network element determines the security decision. As shown in FIG. 10b, the method includes the following steps.

1011: The UE generates a security requirement, and the trusted network element generates a security capability.

1012: The UE sends a registration request message to the AMF, where the registration request message includes the security requirement. Correspondingly, the AMF receives the registration request message.

For example, the security requirement may be included in a UE security capability IE in the registration request message.

1013: The AMF sends a message including the security requirement to the trusted network element. Correspondingly, the trusted network element receives the message including the security requirement.

In a possible implementation, if both the UE and the trusted network element use a distributed ledger technology, the UE may upload the security requirement to a distributed ledger. Correspondingly, the trusted network element may download the security requirement of the UE from the distributed ledger. For descriptions of the distributed ledger, refer to the foregoing related embodiments. Details are not described herein again.

In a possible implementation, after obtaining the security requirement, the trusted network element may further verify whether the security requirement is trusted, and perform step 1014 if the security requirement is trusted. For related descriptions of verifying the security requirement by the trusted network element, refer to the foregoing description. Details are not described herein again.

1014: The trusted network element determines a security decision based on the security requirement and the security capability.

1015: The trusted network element sends a message including the security decision to the AMF. Correspondingly, the AMF receives the message including the security decision.

The message including the security decision may be referred to as a security tag provide response message, a tag response message, or the like. This is not limited in this embodiment of this application.

1016: The AMF sends a registration accept message to the UE, where the registration accept message includes the security decision. Correspondingly, the UE receives the registration accept message.

1017: The UE sends a registration complete message to the AMF. Correspondingly, the AMF receives the registration complete message.

1018: The UE and the trusted network element communicate with each other based on the security decision.

If the UE has a new security requirement, the UE may immediately send an updated security requirement to a network. If the UE does not have a new security requirement, a network may use an old security decision or a security decision of the UE in the service scenario last time.

It may be understood that, in this embodiment of this application, the trusted network element and the UE each may locally generate a security decision based on the method shown in FIG. 8. Details are not described one by one herein.

FIG. 11a and FIG. 11b are schematic flowcharts of security decision negotiation methods according to an embodiment of this application. In FIG. 11a and FIG. 11b, a trusted network element may be used as an independent network function and exist in a core network. To be specific, UE may interact with the trusted network element through an AMF. In the security decision negotiation method, a security granularity of a security tag may be a service granularity. Therefore, a security decision negotiation procedure may be combined with a service procedure of the UE, thereby ensuring efficiency of the service procedure and the security decision negotiation procedure.

As shown in FIG. 11a, the security decision negotiation method includes the following steps.

1101: The UE generates a security requirement, and the trusted network element generates a security capability.

1102: The UE sends a service request (service request) message to the AMF. Correspondingly, the AMF receives the service request message.

1103: The AMF sends a request message to the trusted network element, where the request message is used to request the security capability. Correspondingly, the trusted network element receives the request message.

1104: The trusted network element sends a response message to the AMF, where the response message includes the security capability. Correspondingly, the AMF receives the response message.

1105: The AMF sends a service response (service response) message to the UE, where the service response message includes the security capability. Correspondingly, the UE receives the service response message.

In a possible implementation, if both the UE and the trusted network element use a distributed ledger, the trusted network element may upload the security capability to the distributed ledger, and the UE may download the security capability from the distributed ledger. For descriptions of the distributed ledger, refer to the foregoing related embodiments. Details are not described herein again.

In a possible implementation, after obtaining the security capability, the UE may further verify whether the security capability is trusted, and perform step 1106 if the security capability is trusted. For related descriptions of verifying the security capability by the UE, refer to the foregoing description. Details are not described herein again.

1106: The UE determines a security decision based on the security requirement and the security capability.

1107: The UE sends a service complete (service complete) message to the AMF, where the service complete message includes the security decision. Correspondingly, the AMF receives the service complete message.

1108: The AMF sends a message including the security decision to the trusted network element. Correspondingly, the trusted network element receives the message including the security decision.

1109: The UE and the trusted network element communicate with each other based on the security decision.

FIG. 11a is shown by using an example in which the UE determines the security decision, and FIG. 11b is described by using an example in which the trusted network element determines the security decision. As shown in FIG. 11b, the method includes the following steps.

1111: The UE generates a security requirement, and the trusted network element generates a security capability.

1112: The UE sends a service request message to the AMF, where the service request message includes the security requirement. Correspondingly, the AMF receives the service request message.

1113: The AMF sends a message including the security requirement to the trusted network element. Correspondingly, the trusted network element receives the message including the security requirement.

In a possible implementation, if both the UE and the trusted network element use a distributed ledger technology, the UE may upload the security requirement to a distributed ledger. Correspondingly, the trusted network element may download the security requirement of the UE from the distributed ledger. For descriptions of the distributed ledger, refer to the foregoing related embodiments. Details are not described herein again.

In a possible implementation, after obtaining the security requirement, the trusted network element may further verify whether the security requirement is trusted, and perform step 1114 if the security requirement is trusted. For related descriptions of verifying the security requirement by the trusted network element, refer to the foregoing description. Details are not described herein again.

1114: The trusted network element determines a security decision based on the security requirement and the security capability.

1115: The trusted network element sends a message including the security decision to the AMF. Correspondingly, the AMF receives the message including the security decision.

1116: The AMF sends a service accept (service accept) message to the UE, where the service accept message includes the security decision. Correspondingly, the UE receives the service accept message.

1117: The UE and the trusted network element communicate with each other based on the security decision.

It may be understood that, in this embodiment of this application, the trusted network element and the UE each may locally generate a security decision based on the method shown in FIG. 8. Details are not described one by one herein. For specific descriptions of FIG. 11a and FIG. 11b, refer to the foregoing description, for example, FIG. 10a, FIG. 10b, FIG. 6a, FIG. 6b, FIG. 7a, FIG. 7b, and FIG. 3. Details are not described herein.

FIG. 12a and FIG. 12b are schematic flowcharts of security decision negotiation methods according to an embodiment of this application. In FIG. 12a and FIG. 12b, a trusted network element may be used as an independent network function and exist in a core network. In this embodiment of this application, a security decision negotiation procedure may be combined with an NEF parameter provision service procedure, to implement the security decision negotiation procedure. Generally, when an AF interacts with a network function in a core network, a related message needs to be forwarded through an NEF. Therefore, both FIG. 12a and FIG. 12b are shown by using an example in which an NEF forwards a related message. The NEF may forward the message in a transparent transmission manner or a reproduction manner. This is not limited in this embodiment of this application.

As shown in FIG. 12a, the security decision negotiation method includes the following steps.

1201: The AF generates a security requirement, and the trusted network element generates a security capability.

1202: The AF sends a parameter provision request (parameter provision request) message to the NEF. Correspondingly, the NEF receives the parameter provision request message.

The parameter provision request message may include an Nnef parameter provision request message.

1203: The NEF sends a request message to the trusted network element, where the request message is used to request the security capability. Correspondingly, the trusted network element receives the request message.

1204: The trusted network element sends a response message to the NEF, where the response message includes the security capability. Correspondingly, the NEF receives the response message.

1205: The NEF sends a parameter provision response (parameter provision response) message to the AF, where the parameter provision response message includes the security capability. Correspondingly, the AF receives the parameter provision response message.

1206: The AF determines a security decision based on the security requirement and the security capability.

1207: The AF sends a parameter provision result (parameter provision result) message to the NEF, where the parameter provision result message includes the security decision. Correspondingly, the NEF receives the parameter provision result message.

1208: The NEF sends a message including the security decision to the trusted network element. Correspondingly, the trusted network element receives the message including the security decision.

1209: The AF and the trusted network element communicate with each other based on the security decision.

FIG. 12a is shown by using an example in which the AF determines the security decision, and FIG. 12b is described by using an example in which the trusted network element determines the security decision. As shown in FIG. 12b, the method includes the following steps.

1211: The AF generates a security requirement, and the trusted network element generates a security capability.

1212: The AF sends a parameter provision request message to the NEF, where the parameter provision request message includes the security requirement. Correspondingly, the NEF receives the parameter provision request message.

1213: The NEF sends a message including the security requirement to the trusted network element. Correspondingly, the trusted network element receives the message including the security requirement.

1214: The trusted network element determines a security decision based on the security requirement and the security capability.

1215: The trusted network element sends a message including the security decision to the NEF. Correspondingly, the NEF receives the message including the security decision.

1216: The NEF sends a parameter provision response message to the AF, where the parameter provision response message includes the security decision. Correspondingly, the AF receives the parameter provision response message.

1217: The AF and the trusted network element communicate with each other based on the security decision.

It may be understood that for specific descriptions of FIG. 12a and FIG. 12b, refer to the foregoing description. Details are not described one by one herein again.

The following describes the distributed ledger provided in embodiments of this application.

Embodiments of this application provide an upload procedure, a download procedure, and an update procedure for a security tag in a scenario in which a communication network and a distributed ledger technology are converged. If a core network provides a distributed ledger storage function, a trusted network element may upload a security tag to a distributed ledger. For example, a security capability may be a feature attribute of a capability provider, and a security decision needs to be stored in correspondence with identification information of a requester. Optionally, the security decision may be stored in correspondence with the identification information of the requester and identification information of the capability provider. When a security decision negotiation procedure is re-performed, the trusted network element may download a historical security requirement and security decision from the distributed ledger, thereby improving negotiation efficiency.

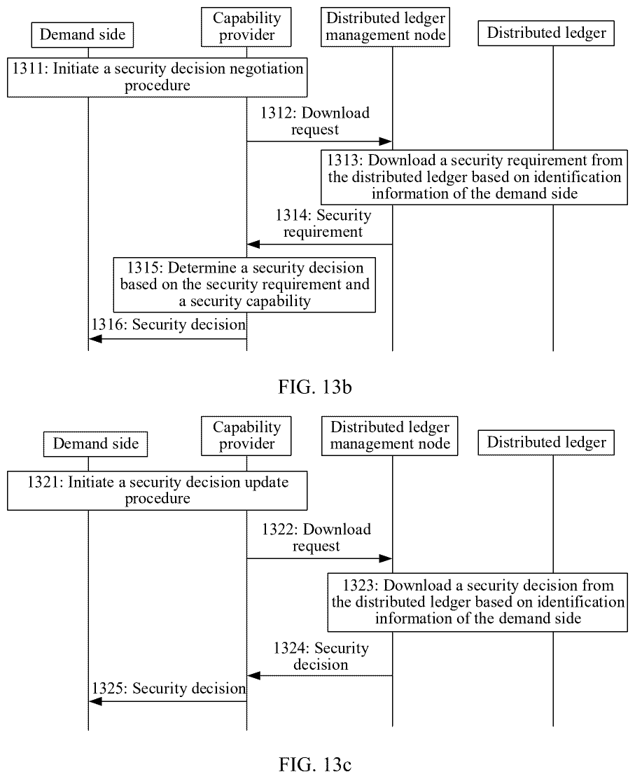

For example, a distributed ledger management node is disposed in the core network, and is responsible for upload, download, and update management of data in all distributed ledgers. FIG. 13a is a schematic flowchart of uploading a security tag according to an embodiment of this application. Similarly, for a method for uploading a security requirement by the requester, refer to FIG. 13a. Details are not described one by one again.

As shown in FIG. 13a, the method includes the following steps.

1301: The capability provider generates a security capability.

1302: The capability provider uploads the security capability. Correspondingly, the distributed ledger management node receives the security capability.

Identification information of the capability provider may be carried when the capability provider sends the security capability.

1303: The distributed ledger management node uploads the security capability to a distributed ledger.

For example, after receiving the security capability, the distributed ledger management node may first verify an identity of the capability provider, and determine whether the capability provider has permission to upload data to the distributed ledger. If the verification succeeds, the distributed ledger management node correspondingly stores the security capability and the identification information of the capability provider in the distributed ledger.

1304: The capability provider and the requester determine a security decision through negotiation.

1305: The capability provider uploads the security decision. Correspondingly, the distributed ledger management node receives the security decision.

When the capability provider sends the security decision to the distributed ledger management node, both the identification information of the capability provider and identification information of the requester may be carried.

1306: The distributed ledger management node uploads the security decision to the distributed ledger.

After receiving the security decision, the distributed ledger management node may verify the identity of the capability provider, and determine whether the capability provider has permission to upload data to the distributed ledger. If the verification succeeds, the distributed ledger management node correspondingly stores the security decision, the identification information of the capability provider, and the identification information of the requester in the distributed ledger.

FIG. 13b is a schematic flowchart of downloading a security tag according to an embodiment of this application. FIG. 13b uses the capability provider as an example. For a method of the requester, refer to FIG. 13b. Details are not described one by one again. As shown in FIG. 13b, the method includes the following steps.

1311: The requester initiates a security decision negotiation procedure.

For example, the requester may initiate the security decision negotiation procedure by sending a request message or indication information to the capability provider, and the request message or the indication information may not carry a security requirement.

It may be understood that the requester may request a security decision update within short time after the security decision negotiation procedure ends. Then, a security decision in a distributed ledger is obtained according to the method provided in this embodiment of this application.

1312: The capability provider sends a download request to the distributed ledger management node. Correspondingly, the distributed ledger management node receives the download request. The download request may be used to request to download a historical security requirement of the requester, and the download request includes identification information of the capability provider and identification information of the requester.

1313: The distributed ledger management node downloads the security requirement from the distributed ledger based on the identification information of the requester.

For example, the distributed ledger management node may verify an identity of the capability provider, and determine whether the capability provider has permission to download data from the distributed ledger. If the verification succeeds, the distributed ledger management node downloads the security requirement from the distributed ledger based on the identification information of the requester.

1314: The distributed ledger management node sends the security requirement to the capability provider. Correspondingly, the capability provider receives the security requirement.

1315: The capability provider determines a security decision based on the security requirement and a security capability.

1316: The capability provider sends the security decision to the requester. Correspondingly, the requester receives the security decision.

FIG. 13c is a schematic flowchart of updating a security decision according to an embodiment of this application. As shown in FIG. 13c, the method includes the following steps.

1321: The requester initiates a security decision update procedure.

For example, the requester may request a security decision update within specific time after a security decision negotiation procedure ends. For example, the requester may send an update request to the capability provider. Correspondingly, the capability provider may receive the update request. The update request is used to request to update a security decision. When the requester initiates the security decision update procedure, the update request may include a new security requirement. Alternatively, before initiating the security decision update procedure, the requester has updated a security requirement to the distributed ledger management node.

1322: The capability provider sends a download request to the distributed ledger management node. Correspondingly, the distributed ledger management node receives the download request. The download request may be used to request to download a security requirement of the requester that is stored in a distributed ledger, such as a historical security requirement or a new security requirement of the requester, and the download request includes identification information of the capability provider and identification information of the requester. It may be understood that, when obtaining a new security requirement, the capability provider may determine a security decision based on the new security requirement and a security capability of the capability provider, and upload the security decision to the distributed ledger management node. For descriptions of uploading the security decision, refer to FIG. 13a. Details are not described herein again. Certainly, after determining the security decision, the capability provider may alternatively directly send the security decision to the requester. In this case, step 1323 and step 1324 shown in FIG. 13c are not mandatory. Optionally, a sequence of step 1322 and step 1321 is not limited in this embodiment of this application. For example, before the requester initiates the security decision update procedure, the capability provider may alternatively determine a security decision based on a new security requirement stored in the distributed ledger.

1323: The distributed ledger management node downloads the security decision from the distributed ledger based on the identification information of the requester.

For example, the distributed ledger management node may verify an identity of the capability provider, and determine whether the capability provider has permission to download data from the distributed ledger. If the verification succeeds, the distributed ledger management node downloads the security decision from the distributed ledger based on the identification information of the requester.

1324: The distributed ledger management node sends the security decision to the capability provider. Correspondingly, the capability provider receives the security decision.

1325: The capability provider sends the security decision to the requester. Correspondingly, the requester receives the security decision.

It may be understood that the methods shown in FIG. 13a and FIG. 13b may include the distributed ledger management node, or may not include the distributed ledger management node. For example, the requester or the capability provider may download a security tag from the distributed ledger, or upload a security tag to the distributed ledger.

The following describes network elements provided in embodiments of this application.

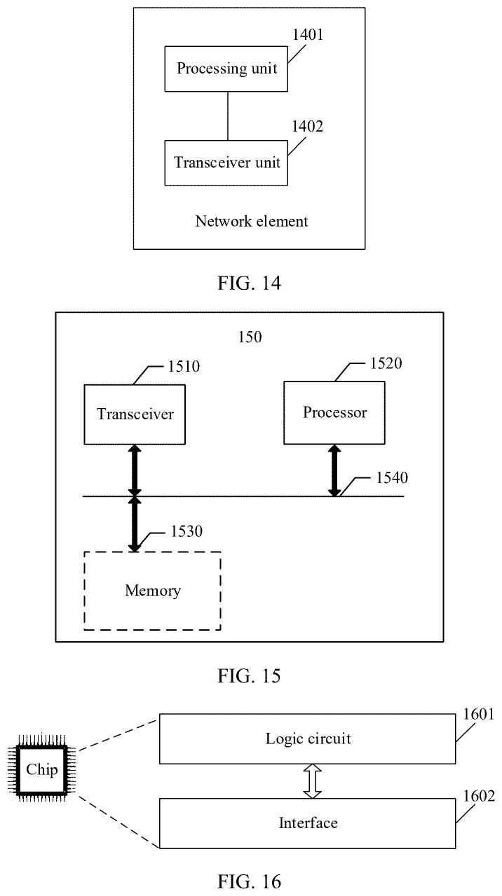

In this application, the network element is divided into functional modules based on the foregoing method examples. For example, functional modules corresponding to functions may be obtained through division, or two or more functions may be integrated into one processing module. The integrated module may be implemented in a form of hardware, or may be implemented in a form of a software functional module. It should be noted that division into the modules in this application is an example, and is merely logical function division. In actual implementation, there may be another division manner. The following describes in detail network elements in embodiments of this application with reference to FIG. 14 to FIG. 16.

FIG. 14 is a diagram of a structure of a network element according to an embodiment of this application. As shown in FIG. 14, the network element includes a processing unit 1401 and a transceiver unit 1402.

In some embodiments of this application, the processing unit 1401 and the transceiver unit 1402 may be configured to perform steps or functions performed by the first network element in the foregoing method embodiments. For example, the processing unit 1401 is configured to determine a security decision based on a security requirement of a requester and a security capability of a capability provider; and the transceiver unit 1402 is configured to send a message including the security decision.

In a possible implementation, the processing unit 1401 is specifically configured to obtain the security requirement and the security capability from a distributed ledger.

In a possible implementation, the transceiver unit 1402 is specifically configured to upload the security decision to the distributed ledger.

In a possible implementation, the processing unit 1401 is specifically configured to: determine a value of a first bit in the security decision based on an operation or mapping result for a value of a first bit in the security requirement and a value of a first bit in the security capability; or determine the security decision based on priority information in the security requirement and the security capability.

The first network element may be the requester, the capability provider, or a third party other than the requester and the capability provider. This is not limited in embodiments of this application.

Optionally, when the network element is the requester, the transceiver unit 1402 is further configured to receive a message including the security capability.

The transceiver unit 1402 is further configured to send a request message, where the request message is used to request the security capability of the capability provider.

Optionally, when the network element is the capability provider, the transceiver unit 1402 is further configured to receive a message including the security requirement.

The transceiver unit 1402 is further configured to send a request message, where the request message is used to request the security requirement of the requester.

In some other embodiments of this application, the processing unit 1401 and the transceiver unit 1402 may be configured to perform steps or functions performed by the requester in the foregoing method embodiments. For example, the transceiver unit 1402 is configured to send a message including a security requirement; and the transceiver unit 1402 is further configured to receive a message including a security decision, where the security decision corresponds to the security requirement.

In this embodiment of this application, the transceiver unit 1402 is specifically configured to: obtain the security requirement through the processing unit 1401, and then output the security requirement. The processing unit 1401 may be further configured to process the security decision, for example, communicate with a capability provider by using the security decision.

In some other embodiments of this application, the processing unit 1401 and the transceiver unit 1402 may be configured to perform steps or functions performed by the capability provider in the foregoing method embodiments. For example, the transceiver unit 1402 is configured to send a message including a security capability; and the transceiver unit 1402 is further configured to receive a message including a security decision, where the security decision is a result of negotiation between the security capability and a security requirement of a requester.

In this embodiment of this application, the transceiver unit 1402 is specifically configured to: obtain the security capability through the processing unit 1401, and then output the security capability. The processing unit 1401 may be further configured to process the security decision, for example, communicate with a requester by using the security decision.

It may be understood that specific descriptions of the transceiver unit and the processing unit shown in this embodiment of this application are merely an example. For specific functions or steps performed by the transceiver unit and the processing unit, refer to the foregoing method embodiments, for example, FIG. 3, FIG. 6a, FIG. 6b, FIG. 7a, FIG. 7b, FIG. 8, FIG. 9a to FIG. 9d, FIG. 10a, FIG. 10b, FIG. 11a, FIG. 11b, FIG. 12a, FIG. 12b, and FIG. 13a to FIG. 13c. Details are not described herein again.

The foregoing describes the network element in embodiments of this application, and the following describes a possible product form of the network element. It should be understood that any form of product that has a function of the network element described in FIG. 14 falls within the protection scope of embodiments of this application. It should be further understood that the following description is merely an example, and a product form of the network element in embodiments of this application is not limited thereto.

In a possible implementation, in the network element shown in FIG. 14, the processing unit 1401 may be one or more processors, and the transceiver unit 1402 may be a transceiver. Alternatively, the transceiver unit 1402 may be a sending unit and a receiving unit, the sending unit may be a transmitter, and the receiving unit may be a receiver. The sending unit and the receiving unit are integrated into one device, for example, a transceiver. In this embodiment of this application, the processor and the transceiver may be coupled, or the like. A connection manner between the processor and the transceiver is not limited in this embodiment of this application.

As shown in FIG. 15, the network element 150 includes one or more processors 1520 and a transceiver 1510.

In some embodiments of this application, the processor 1520 and the transceiver 1510 may be configured to perform steps or functions performed by the first network element in the foregoing method embodiments. For example, the processor 1520 is configured to determine a security decision based on a security requirement of a requester and a security capability of a capability provider; and the transceiver 1510 is configured to send a message including the security decision.

In a possible implementation, the processor 1520 is specifically configured to obtain the security requirement and the security capability from a distributed ledger.

In a possible implementation, the transceiver 1510 is specifically configured to upload the security decision to the distributed ledger.

In a possible implementation, the processor 1520 is specifically configured to: determine a value of a first bit in the security decision based on an operation or mapping result for a value of a first bit in the security requirement and a value of a first bit in the security capability; or determine the security decision based on priority information in the security requirement and the security capability.

Optionally, when the network element is the requester, the transceiver 1510 is further configured to receive a message including the security capability.

The transceiver 1510 is further configured to send a request message, where the request message is used to request the security capability of the capability provider.

Optionally, when the network element is the capability provider, the transceiver 1510 is further configured to receive a message including the security requirement.

The transceiver 1510 is further configured to send a request message, where the request message is used to request the security requirement of the requester.

In some other embodiments of this application, the processor 1520 and the transceiver 1510 may be configured to perform steps or functions performed by the requester in the foregoing method embodiments. For example, the transceiver 1510 is configured to send a message including a security requirement; and the transceiver 1510 is further configured to receive a message including a security decision, where the security decision corresponds to the security requirement.

In some other embodiments of this application, the processor 1520 and the transceiver 1510 may be configured to perform steps or functions performed by the capability provider in the foregoing method embodiments. For example, the transceiver 1510 is configured to send a message including a security capability; and the transceiver 1510 is further configured to receive a message including a security decision, where the security decision is a result of negotiation between the security capability and a security requirement of a requester.

It may be understood that specific descriptions of the transceiver and the processor shown in this embodiment of this application are merely an example. For specific functions or steps performed by the transceiver and the processor, refer to the foregoing method embodiments, for example, FIG. 3, FIG. 6a, FIG. 6b, FIG. 7a, FIG. 7b, FIG. 8, FIG. 9a to FIG. 9d, FIG. 10a, FIG. 10b, FIG. 11a, FIG. 11b, FIG. 12a, FIG. 12b, and FIG. 13a to FIG. 13c. Details are not described herein again.

In implementations of the network element shown in FIG. 15, the transceiver may include a receiver and a transmitter. The receiver is configured to perform a receiving function (or operation), and the transmitter is configured to perform a transmission function (or operation). The transceiver is configured to communicate with another device/apparatus through a transmission medium.

Optionally, the network element 150 may further include one or more memories 1530, configured to store program instructions and/or data (such as a configuration list shown in embodiments of this application). The memory 1530 is coupled to the processor 1520. The coupling in this embodiment of this application is an indirect coupling or a communication connection between apparatuses, units, or modules, may be in an electrical form, a mechanical form, or another form, and is used for information exchange between the apparatuses, the units, or the modules. The processor 1520 may cooperate with the memory 1530. The processor 1520 may execute the program instructions stored in the memory 1530. Optionally, at least one of the one or more memories may be integrated into the processor.

In this embodiment of this application, a specific connection medium between the transceiver 1510, the processor 1520, and the memory 1530 is not limited. In this embodiment of this application, the memory 1530, the processor 1520, and the transceiver 1510 are connected by using a bus 1540 in FIG. 15. The bus is represented by a bold line in FIG. 15. A connection manner between other components is merely an example for description, and constitutes no limitation. The bus may be classified into an address bus, a data bus, a control bus, or the like. For ease of representation, only one bold line is used for representation in FIG. 15, but this does not mean that there is only one bus or only one type of bus.

In embodiments of this application, the processor may be a general-purpose processor, a digital signal processor, an application-specific integrated circuit, a field programmable gate array or another programmable logic device, a discrete gate or transistor logic device, or a discrete hardware component, and may implement or execute the methods, steps, and logical block diagrams disclosed in embodiments of this application. The general-purpose processor may be a microprocessor, or may be any conventional processor or the like. The steps of the method disclosed with reference to embodiments of this application may be directly performed by a hardware processor, or may be performed by a combination of hardware and software modules in the processor.

In embodiments of this application, the memory may include but is not limited to a nonvolatile memory, for example, a hard disk drive (HDD) or a solid-state drive (SSD), a random access memory (RAM), an erasable programmable read-only memory (EPROM), a read-only memory (ROM), a compact disc read-only memory (CD-ROM), or the like. The memory is any storage medium that can be used to carry or store program code in a form of an instruction or a data structure and that can be read and/or written by a computer (for example, the network element shown in this application). However, this is not limited. The memory in embodiments of this application may alternatively be a circuit or any other apparatus that can implement a storage function, and is configured to store program instructions and/or data.

For example, when the network element is configured to implement steps or functions performed by the terminal device, the processor 1520 may be mainly configured to process a communication protocol and communication data, control the entire network element, execute a software program, and process data of the software program. The memory 1530 is mainly configured to store the software program and data. The transceiver 1510 may include a control circuit and an antenna. The control circuit is mainly configured to: perform conversion between a baseband signal and a radio frequency signal, and process the radio frequency signal. The antenna is mainly configured to receive and send radio frequency signals in a form of electromagnetic waves. The input/output apparatus, such as a touchscreen, a display, or a keyboard, is mainly configured to: receive data input by a user and output data to the user. After the network element is powered on, the processor 1520 may read the software program in the memory 1530, explain and execute instructions of the software program, and process data of the software program. When data needs to be sent in a wireless manner, after performing baseband processing on the to-be-sent data, the processor 1520 outputs a baseband signal to the radio frequency circuit; and the radio frequency circuit performs radio frequency processing on the baseband signal and then sends the radio frequency signal to the outside in a form of an electromagnetic wave through the antenna. When data is sent to the network element, the radio frequency circuit receives a radio frequency signal through the antenna, converts the radio frequency signal into a baseband signal, and outputs the baseband signal to the processor 1520. The processor 1520 converts the baseband signal into data, and processes the data.

In another implementation, the radio frequency circuit and the antenna may be disposed independent of the processor that performs baseband processing. For example, in a distributed scenario, the radio frequency circuit and the antenna may be disposed remotely and independent of the network element.

It may be understood that the network element shown in this embodiment of this application may further include more components than those in FIG. 15, and the like. This is not limited in this embodiment of this application. The methods performed by the processor and the transceiver are merely examples. For specific steps performed by the processor and the transceiver, refer to the methods described above.

In another possible implementation, in the network element shown in FIG. 14, the processing unit 1401 may be one or more logic circuits, and the transceiver unit 1402 may be an input/output interface, which may alternatively be referred to as a communication interface, an interface circuit, an interface, or the like. Alternatively, the transceiver unit 1402 may be a sending unit and a receiving unit. The sending unit may be an output interface, and the receiving unit may be an input interface. The sending unit and the receiving unit are integrated into one unit, for example, an input/output interface. As shown in FIG. 16, a network element shown in FIG. 16 includes a logic circuit 1601 and an interface 1602. That is, the processing unit 1401 may be implemented by using the logic circuit 1601, and the transceiver unit 1402 may be implemented by using the interface 1602. The logic circuit 1601 may be a chip, a processing circuit, an integrated circuit, a system on chip (SoC) chip, or the like. The interface 1602 may be a communication interface, an input/output interface, a pin, or the like. For example, FIG. 16 shows an example in which the network element is a chip. The chip includes the logic circuit 1601 and the interface 1602.

In this embodiment of this application, the logic circuit may further be coupled to the interface. A specific connection manner of the logical circuit and the interface is not limited in this embodiment of this application.

In some embodiments of this application, the logic circuit 1601 and the interface 1602 may be configured to perform steps or functions performed by the first network element in the foregoing method embodiments. For example, the logic circuit 1601 is configured to determine a security decision based on a security requirement of a requester and a security capability of a capability provider; and the interface 1602 is configured to output a message including the security decision.

In a possible implementation, the logic circuit 1601 is specifically configured to obtain the security requirement and the security capability from a distributed ledger.

In a possible implementation, the logic circuit 1601 may upload the security decision to the distributed ledger through the interface 1602.

In a possible implementation, the logic circuit 1601 is specifically configured to: determine a value of a first bit in the security decision based on an operation or mapping result for a value of a first bit in the security requirement and a value of a first bit in the security capability; or determine the security decision based on priority information in the security requirement and the security capability.

The first network element may be the requester, the capability provider, or a third party other than the requester and the capability provider. This is not limited in embodiments of this application.

Optionally, when the first network element is the requester, the interface 1602 is further configured to input a message including the security capability.

The interface 1602 is further configured to output a request message, where the request message is used to request the security capability of the capability provider.

Optionally, when the network element is the capability provider, the interface 1602 is further configured to input a message including the security requirement.

The interface 1602 is further configured to output a request message, where the request message is used to request the security requirement of the requester.

In some other embodiments of this application, the logic circuit 1601 and the interface 1602 may be configured to perform steps or functions performed by the requester in the foregoing method embodiments. For example, the interface 1602 is configured to output a message including a security requirement, and the interface 1602 is further configured to input a message including a security decision, where the security decision corresponds to the security requirement.

In this embodiment of this application, the interface 1602 is specifically configured to: obtain the security requirement through the logic circuit 1601, and then output the security requirement. The logic circuit 1601 may be further configured to process the security decision, for example, communicate with a capability provider by using the security decision.

In some other embodiments of this application, the logic circuit 1601 and the interface 1602 may be configured to perform steps or functions performed by the capability provider in the foregoing method embodiments. For example, the interface 1602 is configured to output a message including a security capability, and the interface 1602 is further configured to input a message including a security decision, where the security decision is a result of negotiation based on the security capability and a security requirement of a requester.

In this embodiment of this application, the interface 1602 is specifically configured to: obtain the security capability through the logic circuit 1601, and then output the security capability. The logic circuit 1601 may be further configured to process the security decision, for example, communicate with a requester by using the security decision.

It may be understood that specific descriptions of the logic circuit and the interface shown in this embodiment of this application are merely an example. For specific functions or steps performed by the logic circuit and the interface, refer to the foregoing method embodiments, for example, FIG. 3, FIG. 6a, FIG. 6b, FIG. 7a, FIG. 7b, FIG. 8, FIG. 9a to FIG. 9d, FIG. 10a, FIG. 10b, FIG. 1la, FIG. 11b, FIG. 12a, FIG. 12b, and FIG. 13a to FIG. 13c. Details are not described herein again.

It may be understood that the network element shown in embodiments of this application may implement the method provided in embodiments of this application in a form of hardware or in a form of software. This is not limited in embodiments of this application.

An embodiment of this application further provides a communication system. The communication system includes a requester and a capability provider. The requester and the capability provider may be configured to perform the method in any one of the foregoing embodiments, for example, FIG. 3, FIG. 6a, FIG. 6b, FIG. 7a, FIG. 7b, FIG. 8, FIG. 9a to FIG. 9d, FIG. 10a, FIG. 10b, FIG. 1la, FIG. 11b, FIG. 12a, FIG. 12b, and FIG. 13a to FIG. 13c. Optionally, the communication system may include a requester, a capability provider, and a third party. The third party may be understood as a network element other than the requester and the capability provider. For descriptions of the requester, the capability provider, and the third party, refer to the foregoing method embodiments.

In addition, this application further provides a computer program, and the computer program is used to implement operations and/or processing performed by the first network element in the method provided in this application.

This application further provides a computer program, and the computer program is used to implement operations and/or processing performed by the requester or the capability provider in the method provided in this application.

This application further provides a computer-readable storage medium. The computer-readable storage medium stores computer code. When the computer code is run on a computer, the computer is enabled to perform operations and/or processing performed by the first network element in the method provided in this application.

This application further provides a computer-readable storage medium. The computer-readable storage medium stores computer code. When the computer code is run on a computer, the computer is enabled to perform operations and/or processing performed by the requester or the capability provider in the method provided in this application.

This application further provides a computer program product. The computer program product includes computer code or a computer program. When the computer code or the computer program is run on a computer, operations and/or processing performed by the first network element in the method provided in this application are/is performed.

This application further provides a computer program product. The computer program product includes computer code or a computer program. When the computer code or the computer program is run on a computer, operations and/or processing performed by the requester or the capability provider in the method provided in this application are/is performed.

In the several embodiments provided in this application, it should be understood that the disclosed system, apparatus, and method may be implemented in other manners. For example, the described apparatus embodiments are merely examples. For example, division into the units is merely logical function division. In actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces, and indirect couplings or communication connections between apparatuses or units may be connections in an electrical, mechanical, or another form.

The units described as separate parts may or may not be physically separate, and parts displayed as units may or may not be physical units, may be located in one place, or may be distributed on a plurality of network units. Some or all of the units may be selected based on actual requirements to achieve the technical effects of the solutions provided in embodiments in this application.

In addition, functional units in embodiments of this application may be integrated into one processing unit, or each unit may exist alone physically, or two or more units may be integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in a form of a software product. The computer software product is stored in a readable storage medium and includes several instructions for instructing a computer device (which may be a personal computer, a server, or a network device) to perform all or some of the steps of the methods described in embodiments of this application. The foregoing readable storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application. However, the protection scope of this application is not limited thereto. Any change or replacement readily figured out by a person skilled in the art within the technical scope disclosed in this application shall fall within the protection scope of this application. Therefore, the protection scope of this application shall be subject to the protection scope of the claims.

What is claimed is:

1. A security decision negotiation method, wherein the method comprises:
determining, by a first network element, a security decision based on a security requirement of a requester and a security capability of a capability provider; and
sending, by the first network element, a message comprising the security decision.

2. The method according to claim 1, wherein the first network element comprises the requester, and the method further comprises:
receiving, by the requester, a message comprising the security capability.

3. The method according to claim 2, wherein before the receiving, by the requester, a message comprising the security capability, the method further comprises:
sending, by the requester, a request message, wherein the request message is used to request the security capability of the capability provider.

4. The method according to claim 1, wherein the first network element comprises the capability provider, and the method further comprises:
receiving, by the capability provider, a message comprising the security requirement.

5. The method according to claim 4, wherein before the receiving, by the capability provider, a message comprising the security requirement, the method further comprises:
sending, by the capability provider, a request message, wherein the request message is used to request the security requirement of the requester.

6. The method according to claim 1, wherein before the determining, by a first network element, a security decision based on a security requirement of a requester and a security capability of a capability provider, the method further comprises:
obtaining, by the first network element, the security requirement and the security capability from a distributed ledger.

7. The method according to claim 1, wherein the sending, by the first network element, a message comprising the security decision comprises:
uploading, by the first network element, the security decision to the distributed ledger.

8. The method according to claim 1, wherein the determining, by a first network element, a security decision based on a security requirement of a requester and a security capability of a capability provider comprises:
determining, by the first network element, a value of a first bit in the security decision based on an operation or mapping result for a value of a first bit in the security requirement and a value of a first bit in the security capability; or
determining, by the first network element, the security decision based on priority information in the security requirement and the security capability.

9. The method according to claim 1, wherein the security decision is a result of negotiation based on the security requirement and a security capability of a capability provider.

10. The method according to claim 1, wherein the security requirement comprises at least one of the following information: a security granularity, an authentication method, a key capability, privacy protection, a trustworthiness attestation, cross-operator, or the distributed ledger.

11. The method according to claim 1, wherein the security requirement comprises priority information of at least one of the following information: an encryption algorithm, an integrity protection algorithm, the authentication method, the key capability, the privacy protection, the trustworthiness attestation, the cross-operator, or the distributed ledger.

12. The method according to claim 1, wherein the security decision is used to determine a trustworthiness vector (TV), and the TV comprises at least one of the following information: the privacy protection, the trustworthiness attestation, the cross-operator, or the distributed ledger.

13. The method according to claim 1, wherein the first network element comprises any one of the following: a terminal device, an application function AF, a trusted network element, an access and mobility management function AMF, a network exposure function NEF, an authentication server function AUSF, and an access network device.

14. A first network element, wherein the network element comprises:
a processing unit, configured to determine a security decision based on a security requirement of a requester and a security capability of a capability provider; and
a transceiver unit, configured to send a message comprising the security decision.

15. The network element according to claim 14, wherein the transceiver unit is further configured to receive a message comprising the security capability.

16. The network element according to claim 14, wherein the transceiver unit is further configured to send a request message, wherein the request message is used to request the security capability of the capability provider.

17. The network element according to claim 14, wherein the transceiver unit is further configured to receive a message comprising the security requirement.

18. The network element according to claim 14, wherein the transceiver unit is further configured to send a request message, wherein the request message is used to request the security requirement of the requester.

19. The network element according to claim 14, wherein the processing unit is specifically configured to obtain the security requirement and the security capability from a distributed ledger.

20. A non-transitory computer-readable storage medium, wherein the computer-readable storage medium is configured to store a computer program, and when the computer program is executed, the method according to claim 1 is performed.
